(19) United States
(12) Patent Application Publication
(10) Pub. No.: US 2015/0330791 A1
(43) Pub. Date: Nov. 19, 2015

(54) INERTIAL DEVICE, METHOD, AND PROGRAM

(71) Applicant: Yusuke MATSUSHITA, Kanagawa (JP)

(72) Inventor: Yusuke MATSUSHITA, Kanagawa (JP)

(73) Assignee: RICOH COMPANY, LTD., Tokyo (JP)

(21) Appl. No.: 14/651,273

(22) PCT Filed: Jan. 30, 2014
(86) PCT No.: PCT/JP2014/052706

§ 371 Date: Jun. 11, 2015

(30) Foreign Application Priority Data
Feb. 4, 2013 (JP) 2013-019210
Nov. 6, 2013 (JP) 2013-230548

(51) Int. Cl. G01C 21/16; G01C 21/20

(52) U.S. Cl. CPC G01C 21/16; G01C 21/206

(57) ABSTRACT

An inertial device is disclosed that includes an inertial sensor unit configured to generate an output representing motion of a target holding the inertial device; a storage unit configured to store factors which are associated with different outputs to be generated by the inertial sensor unit, respectively; a generation unit configured to generate a waveform which represents variation of velocity of the inertial device in a predetermined period by using one of the factors corresponding to the output generated by the inertial sensor unit; a combination unit configured to combine the waveform with one or more previous waveforms which have been generated by the generation unit; and an estimation unit configured to estimate a position where the inertial device is currently located using a velocity obtained from the combined waveform.

### TECHNICAL FIELD

An aspect of this disclosure is related to an inertial device, a method, and a program.

### BACKGROUND ART

At a location where a global positioning system (GPS) may not be used for measuring a position such as a building or the underground, the pedestrian dead reckoning (PDR) technique is used in order to estimate a position of a pedestrian on an inertial device including an acceleration sensor and a magnetic field sensor.

A conventional method employing an inertial navigation technique estimates a length of stride and a travelling direction for each step using an estimate model for walking motion and calculates the present and past walking flows (Patent Documents 1 and 2).

A conventional inertial device which performs the inertial navigation technique needs to be attached to the body of a walking user or requires calibration after the user takes the inertial device so that the inertial device estimates the length of stride in an accurate way (Patent Documents 3 through 6).

However, the conventional techniques described in Patent Documents 1 and 2 correct a travel distance and direction for each step of the walking user to estimate a location. Thus, a resolution capability to estimate the location based on user's motion such as walking is limited to a unit of “a single step”, and it is difficult to estimate with a higher resolution capability.

In the conventional techniques described in Patent Documents 3 through 6, the user has to attach the device to his waist and keep his posture; or calibrate the device after taking the device instead of keeping his posture. Thus, the conventional inertial device is inconvenient for the user.

As described above, the inertial device employing the conventional inertial navigation technique has a low resolution capability (i.e. low accuracy) to estimate the user location in the walking motion, and it is inconvenient for the user.

An embodiment of this invention aims to provide an inertial device, a method and a program, which improve the estimate accuracy of the user location and reduce inconvenience to the user.

### SUMMARY OF INVENTION

In one aspect, the present disclosure provides an inertial device, a method, and a program which substantially eliminate one or more problems caused by the limitations and disadvantages of the related art.

In an aspect of this disclosure, there is provided an inertial device including an inertial sensor unit configured to generate an output representing motion of a target holding the inertial device; a storage unit configured to store factors which are associated with different outputs to be generated by the inertial sensor unit, respectively; a generation unit configured to generate a waveform which represents variation of velocity of the inertial device in a predetermined period by using one of the factors corresponding to the output generated by the inertial sensor unit; a combination unit configured to combine the waveform with one or more previous waveforms which have been generated by the generation unit; and an estimation unit configured to estimate a position where the inertial device is currently located using a velocity obtained from the combined waveform.

According to another embodiment of this invention, there is provided a method including generating an output representing motion of a target holding an inertial device using an inertial sensor; generating a waveform which represents variation of velocity of the inertial device in a predetermined period by using one of factors corresponding to the output, the factors being associated with different outputs to be generated by the inertial sensor; combining the waveform with one or more previous waveforms which have been generated in the generating step of the waveform; and estimating a position where the inertial device is currently located using a velocity obtained from the combined waveform.

According to another embodiment of this invention, there is provided a program for causing an inertial device to perform a method including generating an output representing motion of a target holding the inertial device using an inertial sensor; generating a waveform which represents variation of velocity of the inertial device in a predetermined period by using one of factors corresponding to the output, the factors being associated with different outputs to be generated by the inertial sensor; combining the waveform with one or more previous waveforms which have been generated in the generating step of the waveform; and estimating a position where the inertial device is currently located using a velocity obtained from the combined waveform.

### BRIEF DESCRIPTION OF DRAWINGS

FIG. 1 is a drawing illustrating an overview of an inertial device according to an embodiment of this invention.

FIG. 2 is a drawing illustrating an overview of a configuration for an inertial device according to an embodiment of this invention.

FIG. 3 is a block diagram of a functional configuration for an inertial device according to an embodiment of this invention.

FIG. 4 is a drawing illustrating an overview of a procedure to calculate a posture.

FIG. 5 is a drawing illustrating an operation to calculate a posture (roll, pitch, and yaw angles) at the Time Update procedure.

FIG. 6 is a drawing illustrating an operation to calculate a posture (roll, pitch, and yaw angles) at the Time Update procedure.

FIG. 7 is a drawing illustrating an operation to calculate a posture (roll, pitch, and yaw angles) at the Time Update procedure.

FIG. 8 is a drawing illustrating an operation to calculate a posture (roll and pitch angles) at the First Measurement Update procedure.

FIG. 9 is a drawing illustrating an operation to calculate a posture (a yaw angle) at the Second Measurement Update procedure.

FIG. 10 is a drawing illustrating a procedure to detect a peak.

FIG. 11 is a drawing illustrating a procedure to calculate a horizontal component of moving velocity features.

FIG. 12 is a drawing illustrating a procedure to calculate a horizontal component of moving velocity features.

FIG. 13 is a drawing illustrating a determination procedure.

FIG. 14 is a drawing illustrating a procedure to determine variations of moving velocity in the horizontal direction.

FIG. 15 is a drawing illustrating a procedure to estimate traveling direction.

FIG. 16 is a drawing illustrating a procedure to calculate a posture using the TRIAD algorithm.

FIG. 17 is a block diagram of a functional configuration for an inertial device according to an embodiment of this invention.

FIG. 18 is a block diagram of a functional configuration of a velocity estimate unit for an inertial device according to an embodiment of this invention.

FIG. 19 is an example of a table stored in a parameter database managed in an inertial device according to an embodiment of this invention.

FIG. 20 is a drawing illustrating velocity waveforms generated by an inertial device according to an embodiment of this invention.

FIG. 21 is a drawing illustrating velocity waveforms combined by an inertial device according to an embodiment of this invention.

FIG. 22 is a block diagram of a functional configuration of an absolute positional data input unit, an absolute position estimate unit, and a map-matching unit for an inertial device according to an embodiment of this invention.

FIG. 23 is a drawing illustrating a relationship between a signal-to-noise ratio of radio field strength and an interval to receive radio signals.

FIG. 24 is a drawing illustrating a calculation of the current position in a time update procedure.

FIG. 25 is a drawing illustrating a calculation of the current position in a time update procedure.

FIG. 26 is a drawing illustrating a calculation of the current position in a time update procedure.

FIG. 27 is a drawing illustrating a calculation of the current position in a time update procedure.

FIG. 28 is a drawing illustrating an equation of the Extended Kalman Filter (prior art).

FIG. 29 is a drawing illustrating variables used in the Time Update procedure (prior art).

FIG. 30 is a drawing illustrating variables used in the Measurement Update procedure (prior art).

FIG. 31 is a drawing illustrating motion characteristics for walking in the vertical direction.

FIG. 32 is a drawing illustrating motion characteristics for walking in the horizontal direction.

FIG. 33 is a drawing illustrating a result of estimating velocities for walking motion.

FIG. 34 is a drawing illustrating a result of estimating positions for walking motion.

FIG. 35 is a drawing illustrating a result of estimating positions for walking motion.

FIG. 36 is a drawing illustrating a result of correcting estimated results using absolute positional data.

FIG. 37 is a drawing illustrating variation of an estimated value for a measurement error for walking motion.

### DESCRIPTION OF EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### 1. Overview

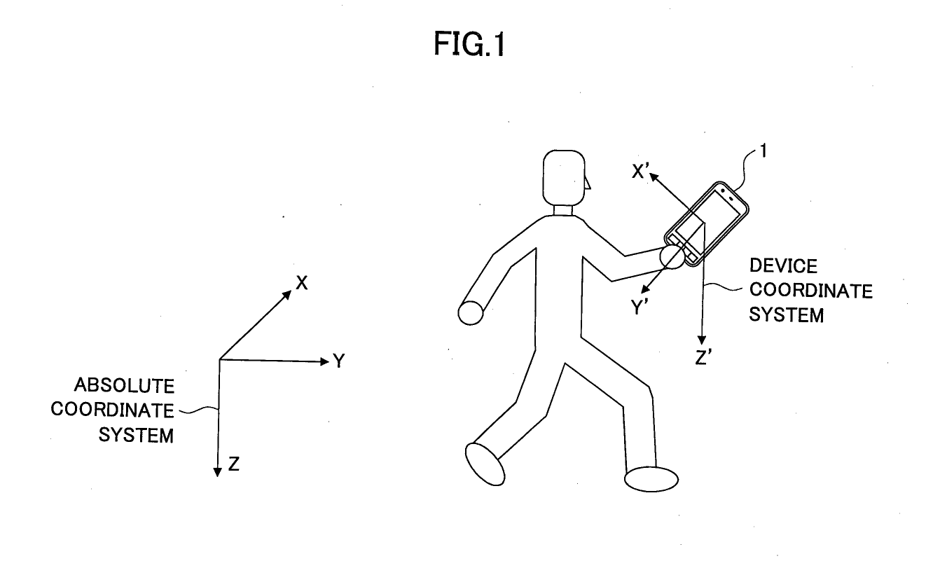

FIG. 1 is a drawing illustrating an overview of an inertial device according to an embodiment of this invention. FIG. 1 shows a user who walks with the inertial device 1. In the present specification, a direction to which the user walks is represented as the x-axis, a direction which is vertical to the x-axis and on a parallel with the ground is represented as the y-axis, and a direction which is vertical to both the x-axis and the y-axis is represented as the z-axis.

The inertial device 1 is portable and may be carried by the user (e.g. a cell phone, a smartphone, a personal digital assistant or a notebook PC). The inertial device 1 has inertial sensors (e.g. an acceleration sensor, an angular velocity sensor, a magnetic field sensor, etc.), which is implemented in a common smartphone. The inertial device 1 may detect variations of acceleration and angular velocity and a direction of the inertial device 1.

The inertial device 1 according to an embodiment of the invention may obtain sensor data including acceleration on three axes (3 axis acceleration), angular velocity on three axes (3 axis angular velocity), and strength of the magnetic field on three axes (3 axis magnetic field strength) as needed. A coordinate system depends on a device or sensor type, which is called the “device coordinate system”. Thus, measured values obtained in the device coordinate system are converted into the an absolute coordinate system.

The inertial device 1 may obtain converted acceleration (vector) in the absolute coordinate system. In particular, the inertial device 1 may obtain a vertical component and a horizontal component of the acceleration (the converted 3 axis acceleration) from the sensor data by converting the coordinate system and removing gravity from the converted sensor data. The inertial device 1 may identify the time when one foot of the target passes the other foot after the pivot foot lands on the ground using waveforms indicating variations of the converted acceleration in the vertical direction of the converted 3 axis acceleration obtained and stored as needed. Since the time indicates that the time when the lower turning points (lower peaks) are shown in the waveform, the time is called a “peak time” or a “peak position”.

Next, the inertial device 1 may integrate the horizontal component of the converted acceleration in a predetermined period around the peak position. Here, the calculated values are referred to as a “horizontal component of the converted velocity vector”. The inertial device 1 may determine that the obtained data indicates an actual walking motion (or a traveling action) of the target or not by using the calculated horizontal component of the converted velocity vector; a cycle of the moving action of the target; and the peak value of the vertical component of the converted acceleration or the peak amplitude (the value of peak acceleration in the vertical direction). Here, a cycle of the moving action of the target is called a “moving cycle”. An example of the moving cycle is a human's walking cycle. In addition, the actual walking motion or the traveling action of the target is simply represented as the “walking motion” (including any actions other than “walking”, though).

Next, when the inertial device 1 determines that the data derives from the actual walking motion, the inertial device 1 may combine the horizontal component of the converted velocity vectors around the time'when the data is obtained, and the inertial device 1 may calculate a traveling direction vector indicating that the user takes a step as needed. Subsequently, the inertial device 1 may estimate a traveling direction indicated by combination of the last traveling direction vector and the previous direction vector.

In this way, since the inertial device 1 may estimate a traveling direction without Fourier transformation (FT) or principal component analysis, the inertial device 1 does not need to perform high rate sensor sampling due to low frequency of the acceleration signal for the walking motion of the target. In addition, since the inertial device 1 does not need to perform FT for a plurality of walking steps, an accuracy of the estimated traveling direction per step and a response of the estimation are improved. It makes it possible to reduce costs and downside the device.

Furthermore, since the way to hold the inertial device for the user is not limited, the usability may be improved. That merit is especially advantageous when the inertial device provides a navigational function for the user.

The inertial device 1 may be implemented as a device such as a music player, a health monitor, a watch, etc. other than the above-mentioned device. In addition, the inertial device 1 may be incorporated into another device (e.g. a walking robot or a collar for an animal). It makes it possible to estimate a traveling direction of various types of creatures or objects which makes a motion in the vertical direction within a certain cycle.

### 2. Hardware Configuration

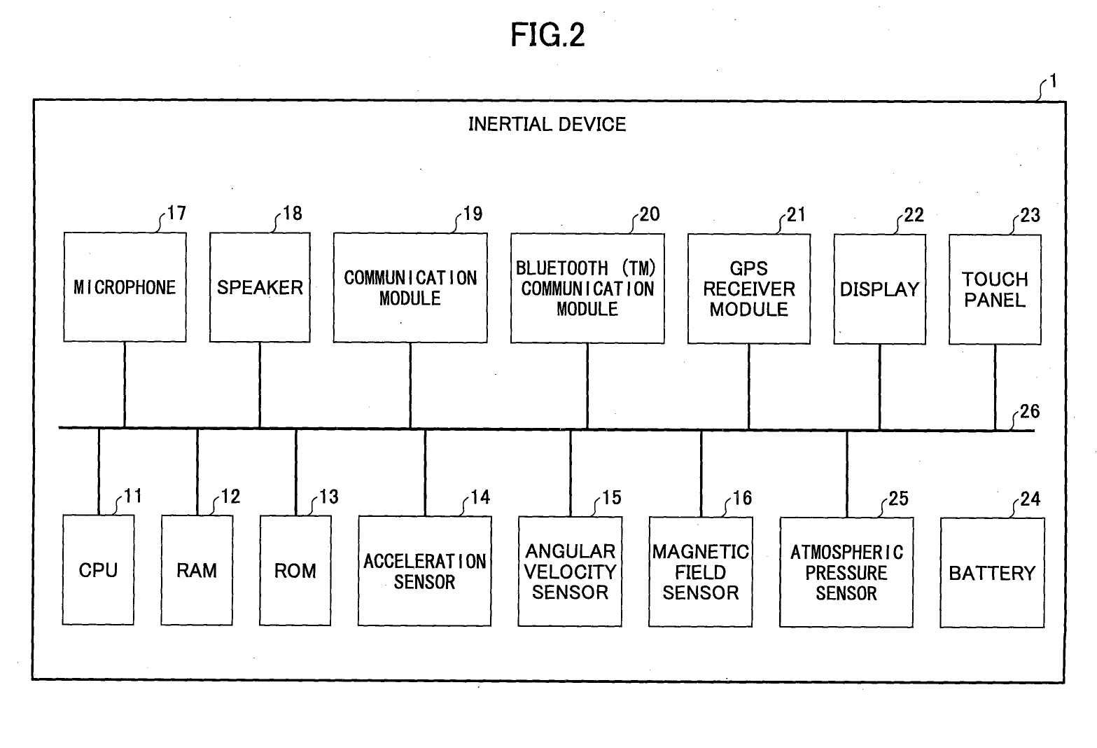

FIG. 2 is a drawing illustrating an overview of a configuration for the inertial device 1 according to an embodiment of this invention. In the example shown in FIG. 2, the inertial device 1 is implemented as a mobile device such as a smartphone.

The inertial device 1 has a CPU 11, a RAM 12, a ROM 13, an acceleration sensor 14, an angular velocity sensor 15, a magnetic field sensor 16, a microphone 17, a speaker 18, a communication module 19, a Bluetooth™ communication module 20, a GPS receiver module 21, a display 22, a touch panel 23, a battery 24, an atmospheric pressure sensor 25, and a bus 26.

The CPU 11 may execute programs controlling the inertial device 1. The RAM 12 may work as a work area for the CPU 11. The ROM 13 may store the programs executed by the CPU 11 and data required to execute the programs. The acceleration sensor 14 may detect acceleration in the X′-axis, Y′-axis, and Z′-axis directions in the device coordinate system used by the inertial device 1. The angular velocity sensor 15 (or a gyroscope) may detect angular velocity in the X′-axis, Y′-axis, and Z′-axis directions in the device coordinate system used by the inertial device 1. The magnetic field sensor 16 may output a 3 dimensional vector causing the compass to point north and may be used to detect an aspect of the inertial device 1. The atmospheric pressure sensor 25 may measure an air pressure and detect altitude of the inertial device 1.

The microphone 17 may convert a voice into an electronic signal. The speaker 18 may output an electronic signal as a sound. The communication module 19 may communicate with other devices connected via a 3G network and/or a wireless LAN. The Bluetooth™ communication module 20 may communicate with other devices using Bluetooth protocols. The GPS receiver module 21 may receive positioning signals transmitted from GPS satellites or Indoor Messaging System (IMES) transmitters.

The display 22 may provide a screen for a user. The touch panel 23 may accept input from the user. The battery 24 may supply power to the inertial device 1. The bus 26 may connect the above-mentioned devices (except the battery 24) with each other.

The microphone 17, the speaker 18, the communication module 19, the Bluetooth™ communication module 20, the GPS receiver module 21, the display 22, the touch panel 23, and the atmospheric pressure sensor 25 are optional elements for the inertial device 1. For example, when the inertial device 1 is implemented as a health monitor which does not have a display screen, the inertial device 1 does not need to have such components modules.

Alternatively, the inertial device 1 may have a communication device according to other communication protocols (e.g. ZigBee™) instead of the Bluetooth™ communication module 20.

### 3. Functions

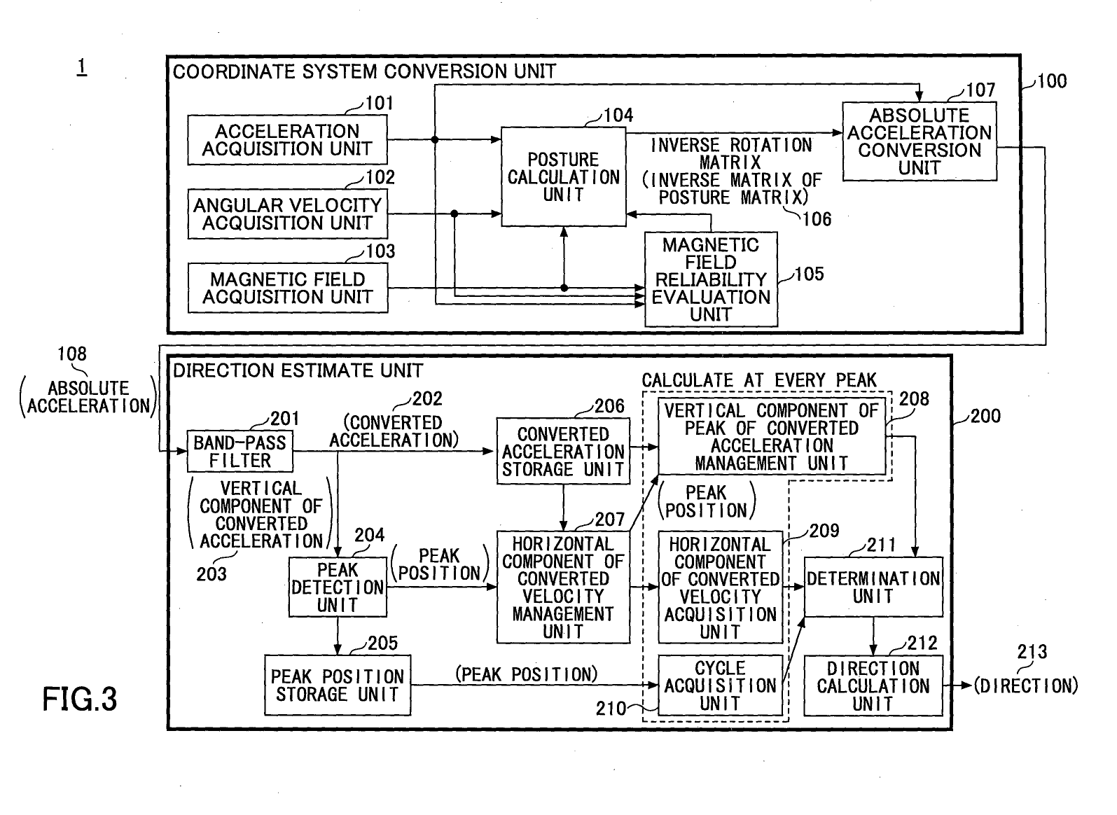

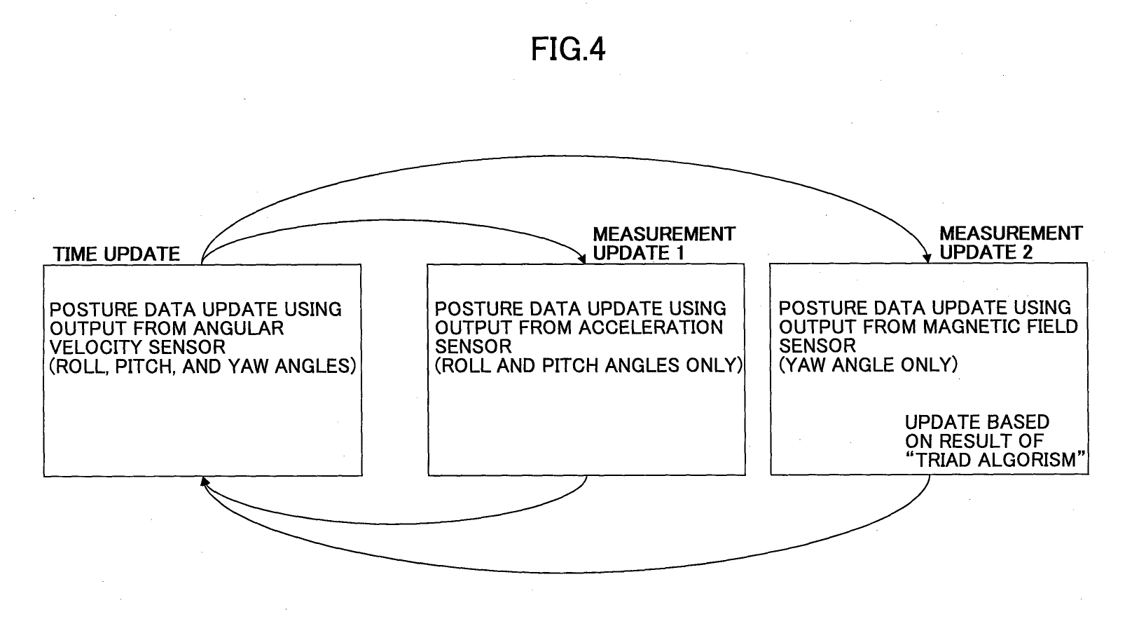

FIG. 3 is a block diagram of a functional configuration for the inertial device 1. The functions of the inertial device 1 may be roughly divided into a “Change of Coordinate Systems” function and an “Estimation for Travelling Direction” function.

### 3.1 Change of Coordinate Systems

A coordinate system conversion unit 100, which performs a conversion of a coordinate system on the inertial device 1, has an acceleration acquisition unit 101, an angular velocity acquisition unit 102, a magnetic field acquisition unit 103, a posture calculation unit 104, a magnetic field reliability evaluation unit 105, and an absolute acceleration conversion unit 107. The coordinate system conversion unit 100 may convert 3 axis acceleration obtained from the acceleration sensor 104 in the device coordinate system into absolute acceleration in the absolute coordinate system.

The absolute coordinate system is used to handle coordinate values measured by various kinds of sensors, which includes the World Geodetic System 1984 (WGS84) used by GPS and the Orthogonal Coordinate System such as the Universal Transverse Mercator Coordinate (UTM) System. Thus, in the absolute coordinate system, a position or a direction of a target may be represented by a distance relationship from the origin which is fixed in a space. The absolute coordinate system is called the “World Coordinate System”. On the other hand, the device coordinate system is called the “Body Coordinate System”, which defines the origin at a point inside the inertial device 1 and three axes (i.e. x-axis, y-axis, and z-axis) which are orthogonal to each other.

The acceleration acquisition unit 101 may acquire variation of the three-axis acceleration detected by the acceleration sensor 14.

The angular velocity acquisition unit 102 may obtain variation of the three-axis angular velocity detected by the angular velocity sensor 15. Here, the angular velocity may be acquired in the device coordinate system in common with the acceleration.

The magnetic field acquisition unit 103 may acquire the three-dimension magnetic field vector pointing to the magnetic north, which is detected by the magnetic field sensor 106. In this way, the magnetic field acquisition unit 103 may get a direction of the inertial device 1. Here, the direction may be acquired in the device coordinate system in common with the acceleration.

The posture calculation unit 104 may calculate the current posture of the inertial device 1 using the sensor data obtained by the acceleration acquisition unit 101, the angular velocity acquisition unit 102, and the magnetic field acquisition unit 103, and the posture calculation unit 104 may calculate an inverse rotation matrix 106 by an inverse matrix calculation to the calculated posture data (a rotation matrix).

The data obtained by the magnetic field acquisition unit 103 may be unreliable due to an environmental magnetic field in an in-door environment. Thus, the posture calculation unit 104 may use the data obtained by the magnetic field acquisition unit 103 only when the magnetic field reliability evaluation unit 105 (explained later) determines that the data is reliable.

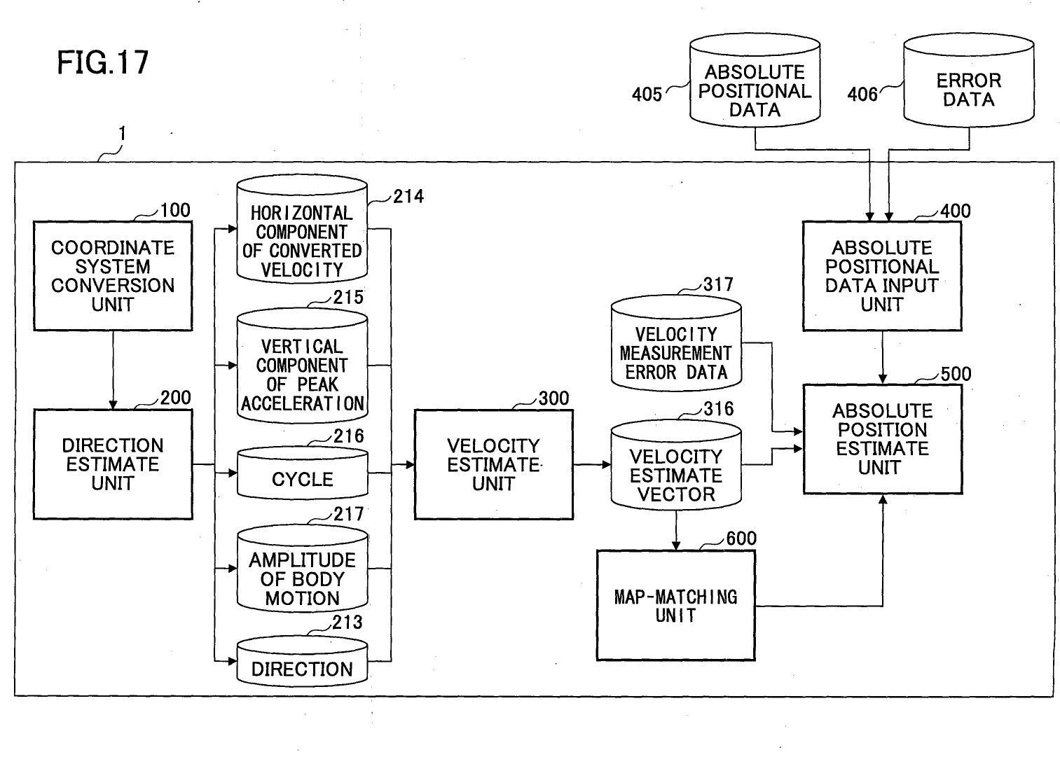

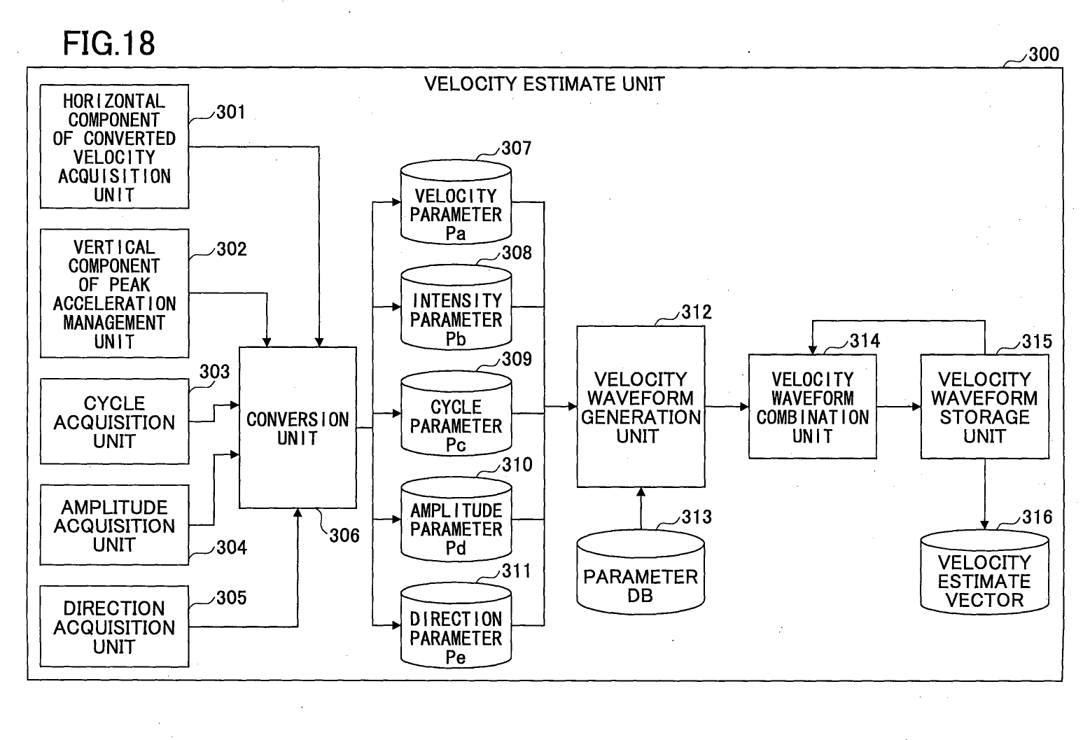

The posture calculation unit 104 may calculate a matrix representing the posture of the inertial device 1 using the Extended Kalman Filter, which is commonly used in the art (See Non-Patent Documents 1, 2, FIGS. 17, 18), and the posture calculation unit 104 may invert the matrix. The detailed procedure is explained below.

### General Equations of the Extended Kalman Filter

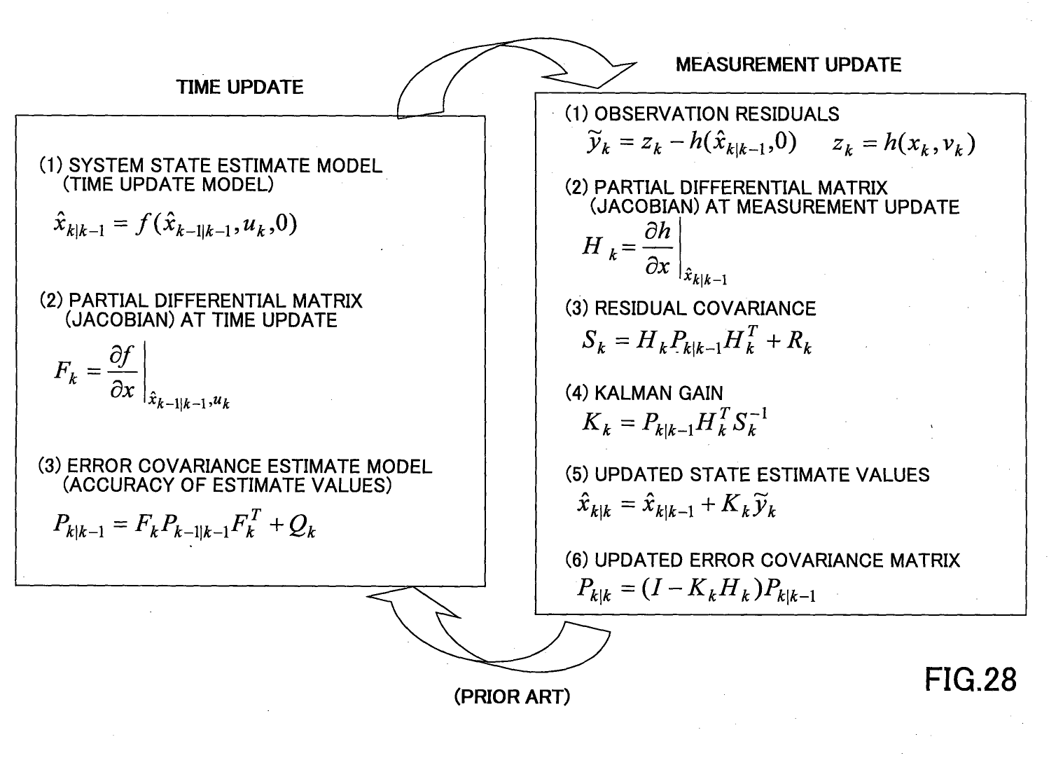

FIG. 28 is a drawing illustrating an equation of the Extended Kalman Filter. In the calculation of the Kalman Filter, “Time Update” and “Measurement Update” procedures are executed in order to forward a time step. In the Time Update procedure, an estimated state at the present time is calculated from an estimated state at a previous time. In the Measurement Update procedure, the estimated values are corrected using a measurement at the present time and thereby a more precise state may be estimated. By repeating such procedures, the optimal state variables are estimated.

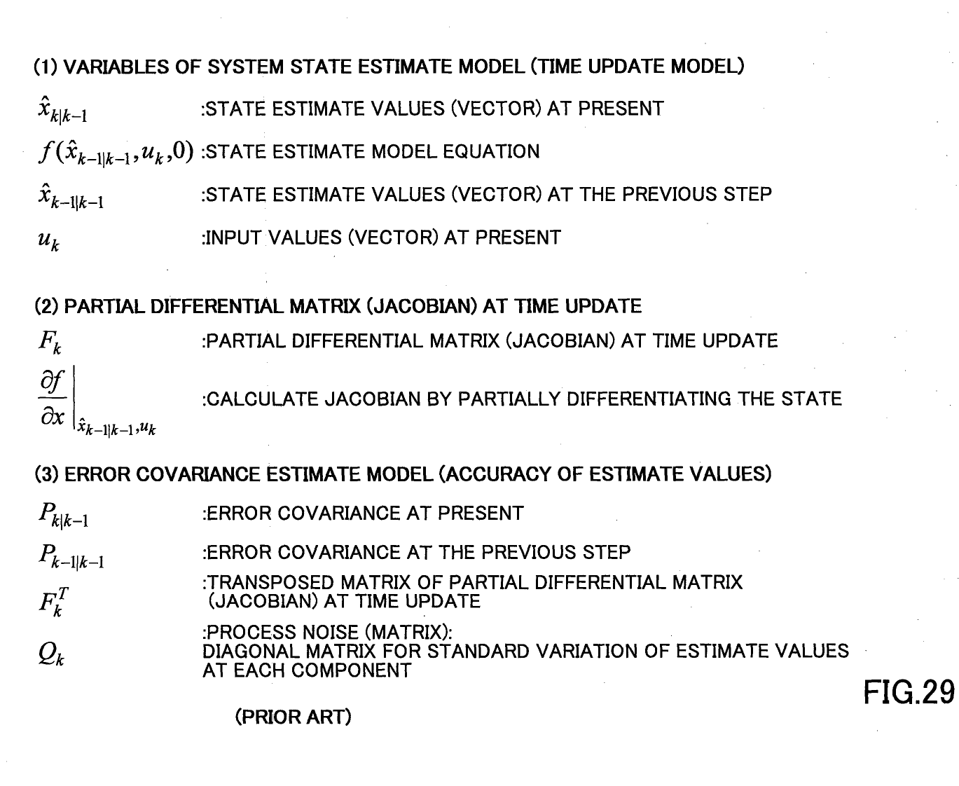

FIG. 29 is a drawing illustrating variables used in the Time Update procedure (prior art). The variables are explained, which correspond to the equations (1)-(3) in the frame named “Time Update” as shown in FIG. 28. Here, “k” indicates a discrete step time, and “k−1” indicates time at the previous step.

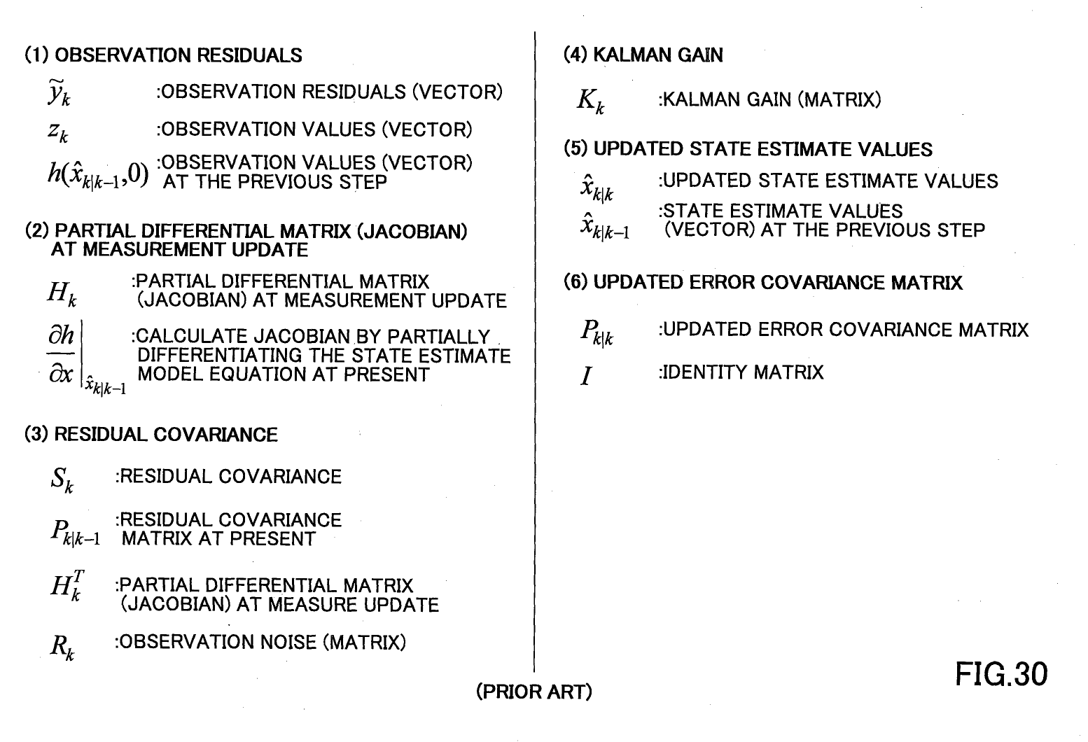

FIG. 30 is a drawing illustrating variables used in the Measurement Update procedure. The variables are explained, which correspond to the equations (1)-(6) in the frame named “Measurement Update” as shown in FIG. 28.

### Application of the Extended Kalman Filter

The posture calculation unit 104 may use the Time Update procedure in the Extended Kalman Filter to update the posture data derived from the angular velocity sensor 15 (roll, pitch, and yaw angles). In addition, the posture calculation unit 104 may use the Measurement Update procedure in the Extended Kalman Filter to update the posture data derived from the acceleration sensor 14 (roll and pitch angles) (hereinafter called the “first measurement update procedure”). Furthermore, the posture calculation unit 104 may use the Measurement Update procedure to update the posture data derived from the magnetic field sensor 16 (a yaw angle) (hereinafter called the “second measurement update procedure”).

In this way, the posture calculation unit 104 may form a seven state Extended Kalman Filter. The posture calculation unit 104 may repeatedly execute the Time Update procedure and the two Measurement Update procedures in parallel and estimate the posture and a gyro zero point bias value. The posture is represented using a quaternion (vector) as shown below.

$$q = [ \begin{matrix}w \\ x \\ y \\ z\end{matrix} ] = [ \begin{matrix}{q}_{0} \\ {q}_{1} \\ {q}_{2} \\ {q}_{3}\end{matrix} ]$$

The quaternion vector has four variables and may represent a posture of an object. A posture representation using roll, pitch and yaw angles has a problem about a singularity called “Gimbal Lock”, but the quaternion may represent any posture without the singularity. The gyro zero point bias value may be represented using three variables bxₖ, byₖ, bzₖ corresponding to three axes (b is a constant).

In the following, the above-mentioned three procedures (1) to (3) are explained.

### The Time Update Procedure

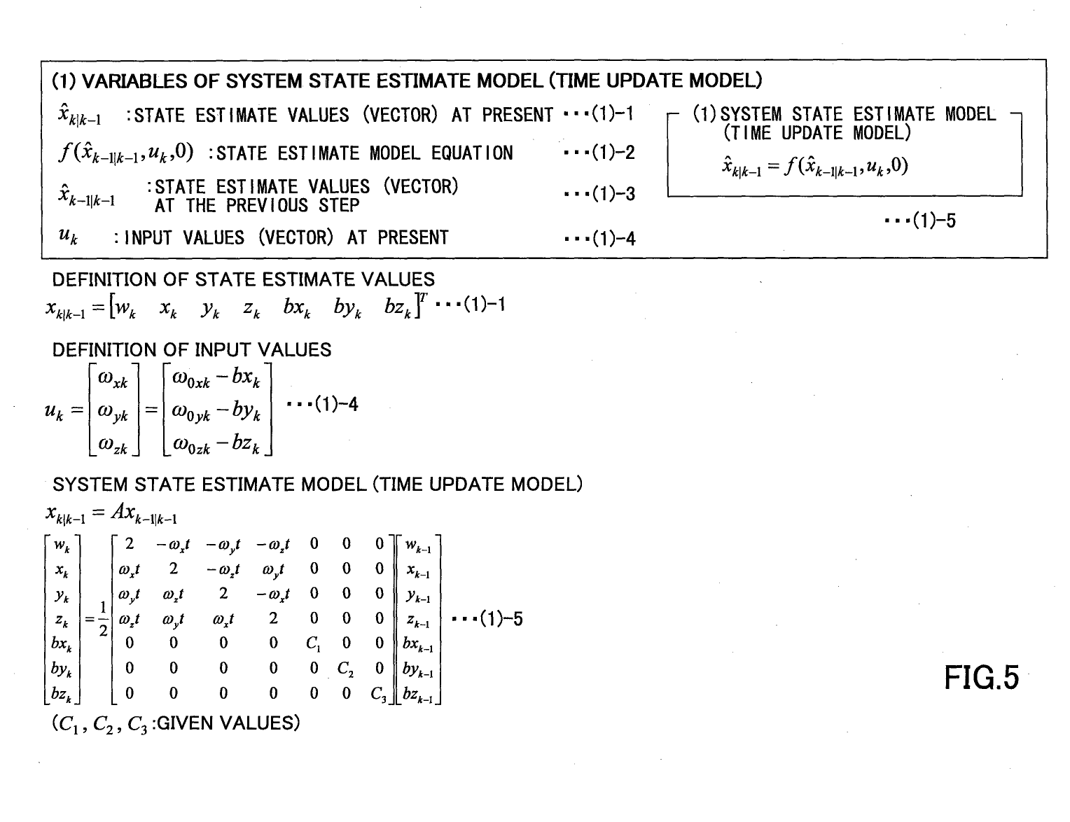

First, with reference to FIGS. 5-7, the time update procedure in the Extended Kalman Filter is explained. The posture calculation unit 104 may execute the procedure and perform time integration according to the time update procedure in the Extended Kalman Filter using gyro output values as input in a state estimation model explained later. In this way, the updated quaternion vector q and an error covariance matrix P are obtained (roll, pitch, and yaw angles).

FIG. 5 is a drawing illustrating (1) variables of the system state estimate model according to an embodiment of the invention in the general equation of the Extended Kalman Filter. Here, the state estimate values at the present are defined as the equation (1)-1 in FIG. 5 using the quaternion vector and the gyro zero point bias value.

x_{k|k-1}=[wₖ xₖ yₖ zₖ bxₖ byₖ bzₖ]^{T}

The input values uₖ are defined as the equation (1)-4 in FIG. 5 using the output values (ω₀ₓₖ, ω_{0yk}, ω_{0zk}) (rad/sec) of the angular velocity sensor.

$${u}_{k} = [ \begin{matrix}{ω}_{xk} \\ {ω}_{yk} \\ {ω}_{xk}\end{matrix} ] = [ \begin{matrix}{ω}_{0 xk} - {bx}_{k} \\ {ω}_{0 yk} - {by}_{k} \\ {ω}_{0 zk} - {bz}_{k}\end{matrix} ]$$

Thus, the values (ω₀ₓₖ, ω_{0yk}, ω_{0zk}) indicate angular velocity in which zero point values are substituted and there is no offset. The system state estimation model is represented as the equation (1)-5 in FIG. 5 where C₁, C₂, C₃ are constant.

$$[ \begin{matrix}{w}_{k} \\ {x}_{k} \\ {y}_{k} \\ {z}_{k} \\ {bx}_{k} \\ {by}_{k} \\ {bz}_{k}\end{matrix} ] = \frac{1}{2} [ \begin{matrix}2 & - {ω}_{x} t & - {ω}_{y} t & - {ω}_{z} t & 0 & 0 & 0 \\ {ω}_{x} t & 2 & - {ω}_{z} t & {ω}_{y} t & 0 & 0 & 0 \\ {ω}_{y} t & {ω}_{z} t & 2 & - {ω}_{x} t & 0 & 0 & 0 \\ {ω}_{z} t & {ω}_{y} t & {ω}_{x} t & 2 & 0 & 0 & 0 \\ 0 & 0 & 0 & 0 & {C}_{1} & 0 & 0 \\ 0 & 0 & 0 & 0 & 0 & {C}_{2} & 0 \\ 0 & 0 & 0 & 0 & 0 & 0 & {C}_{3}\end{matrix} ] [ \begin{matrix}{w}_{k - 1} \\ {x}_{k - 1} \\ {y}_{k - 1} \\ {z}_{k - 1} \\ {bx}_{k - 1} \\ {by}_{k - 1} \\ {bz}_{k - 1}\end{matrix} ]$$

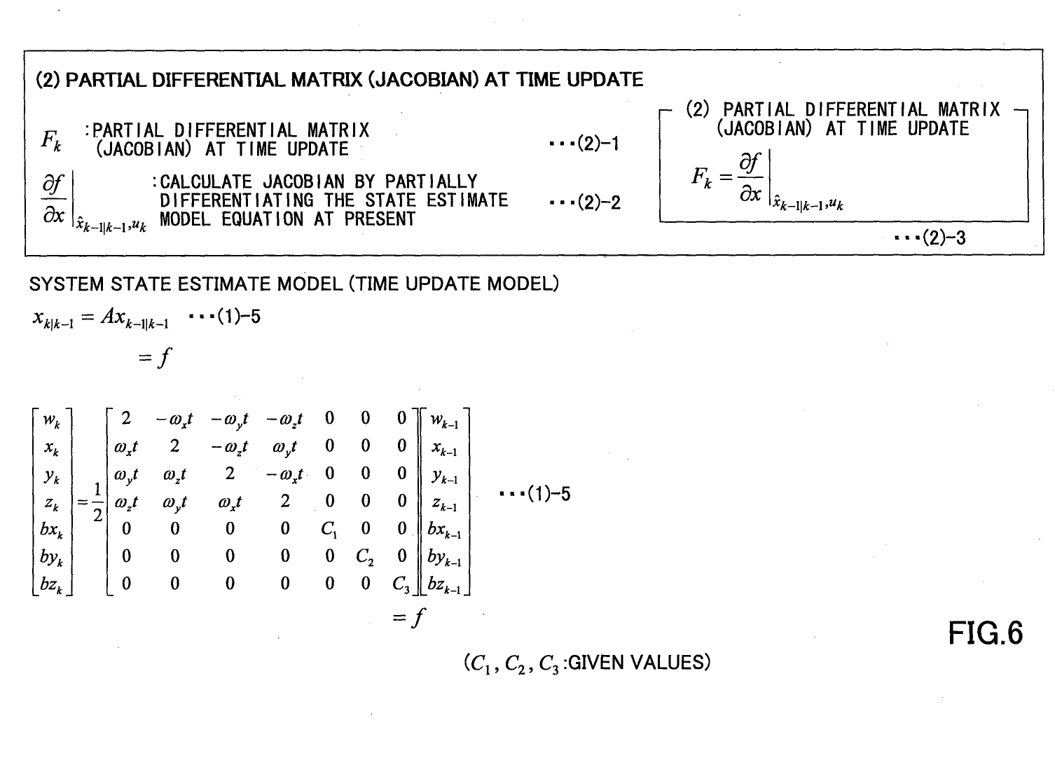

FIG. 6 is a drawing illustrating a (2) partial differential matrix (Jacobian) at the time update procedure according to an embodiment of the invention in the general equation of the Extended Kalman Filter. As shown in FIG. 5, the system state estimation model is represented as the equation (1)-5. A right side of the equation (1)-5 is “f”. Thus, the partial differential on the right results in the partial differential matrix in the time update procedure.

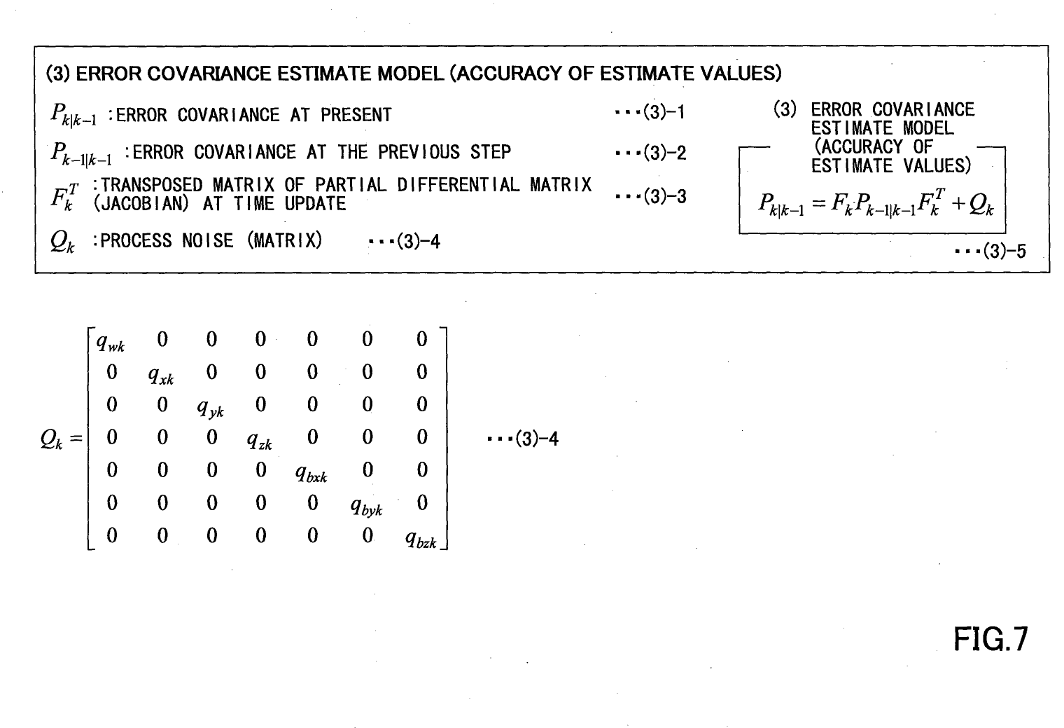

FIG. 7 is a drawing illustrating an error covariance estimate model P_{k|k-1} according to an embodiment of the invention in the general equation of the Extended Kalman Filter. Process noise Qₖ is determined in a system identification process in advance.

$${Q}_{k} = [ \begin{matrix}{q}_{wk} & 0 & 0 & 0 & 0 & 0 & 0 \\ 0 & {q}_{xk} & 0 & 0 & 0 & 0 & 0 \\ 0 & 0 & {q}_{yk} & 0 & 0 & 0 & 0 \\ 0 & 0 & 0 & {q}_{zk} & 0 & 0 & 0 \\ 0 & 0 & 0 & 0 & {q}_{bxk} & 0 & 0 \\ 0 & 0 & 0 & 0 & 0 & {q}_{byk} & 0 \\ 0 & 0 & 0 & 0 & 0 & 0 & {q}_{bzk}\end{matrix} ]$$

The error covariance matrix at the present time P_{k|k-1} may be calculated using the process noise Qₖ, the error covariance matrix at the previous step, the partial differential matrix (Jacobian) in the time update procedure Fₖ, and its transposed matrix Fₖ^{T} (the equation (3)-5 in FIG. 7). The error covariance matrix at the present time P_{k|k-1} and the matrix P_{k-1|k-1} have 7×7 elements which are real.

The posture calculation unit 104 may execute the time update procedure in the Extended Kalman Filter using the above mentioned model and variables; calculate the posture of the inertial device 1 in the absolute coordinate system; and calculate the inverse rotation matrix of the matrix indicating the posture.

### The First Measurement Update Procedure

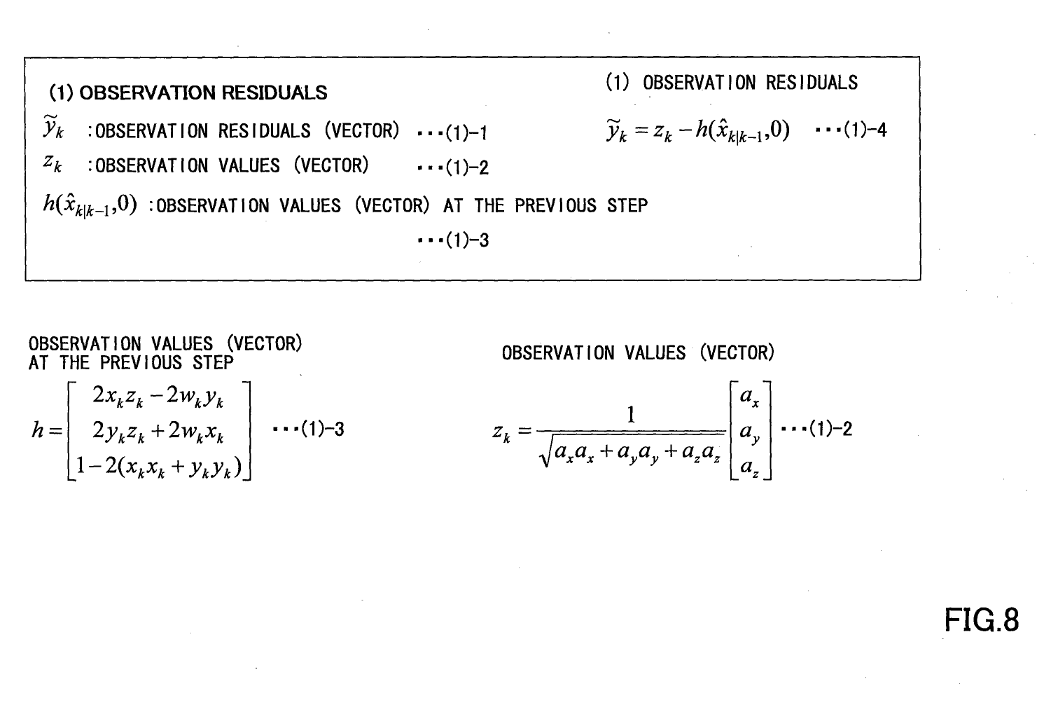

FIG. 8 shows a drawing illustrating the first measurement update procedure in the Extended Kalman Filter. By executing the procedure, the posture calculation unit 104 may compare angular data in the horizontal direction obtained by the acceleration acquisition unit 101 with horizontal angular data of the present quaternion vector, and the posture calculation unit 104 may correct the difference.

FIG. 8 shows variables included in observation residuals (1) in the general equation of the Extended Kalman Filter.

\tilde{y}ₖ

First, the observation values (vector) at the previous step h are represented as the equation (1)-3 in FIG. 8.

$$h = [ \begin{matrix}2 {x}_{k} {z}_{k} - 2 {w}_{k} {y}_{k} \\ 2 {y}_{k} {z}_{k} + 2 {w}_{k} {x}_{k} \\ 1 - 2 ( {x}_{k} {x}_{k} + {y}_{k} {y}_{k} )\end{matrix} ]$$

The elements included in the above equation derive from a three dimensional rotation matrix (4×4) and the elements are predetermined. The observation values (vector) zₖ is represented as the equation (1)-2 in FIG. 8.

$${z}_{k} = \frac{1}{\sqrt{{a}_{x} {a}_{x} + {a}_{y} {a}_{y} + {a}_{z} {a}_{z}}} [ \begin{matrix}{a}_{x} \\ {a}_{y} \\ {a}_{z}\end{matrix} ]$$

Here, the values (aₓ, a_{y}, a_{z}) are output from the acceleration sensor 14, which are obtained by the acceleration acquisition unit 101. Using the above-mentioned h and zₖ, the observation residuals are calculated as shown below.

\tilde{y}ₖ

The partial differential matrix (Jacobian) in the Measurement Update procedure Hₖ in the general equation of the Extended Kalman Filter (1) is obtained by calculating the partial differential of the observation values h shown in the equation (1)-3 in FIG. 8.

The residual covariance Sₖ in the general equation of the Extended Kalman Filter (3) is calculated using the observation noise (matrix) Rₖ, the partial differential matrix in the Measurement Update procedure Hₖ, its transposed matrix Hₖ^{T}, and the error covariance matrix at the present time P_{k|k-1}.

$${R}_{k} = [ \begin{matrix}{r}_{1} & 0 & 0 \\ 0 & {r}_{2} & 0 \\ 0 & 0 & {r}_{3}\end{matrix} ]$$

Here, the values (r₁, r₂, r₃) are variances which are determined in a device evaluation process for the acceleration sensor 14 in advance.

The Kalman gain Kₖ in the general equation of the Extended Kalman Filter (4) is calculated using the error covariance matrix P_{k|k-1} at the present time, the transposed matrix of the partial differential matrix in the Measurement Update procedure Hₖ^{T}, and the inverse matrix of the residual covariance Sₖ⁻¹. The Kₖ has 7×3 elements, which are actual numbers.

Similarly, the state estimate values x_{k|k} (5) and the updated error covariance matrix P_{k|k} (6) in the general equation of the Extended Kalman Filter are calculated using the above-mentioned variables.

The posture calculation unit 104 may execute, using the above-mentioned model and variables, the Measurement Update procedure in the Extended Kalman Filter; compare the angle data in the horizontal direction with the horizontal angle data of the present quaternion vector; and correct the difference (for roll and pitch angles only).

### The Second Measurement Update Procedure

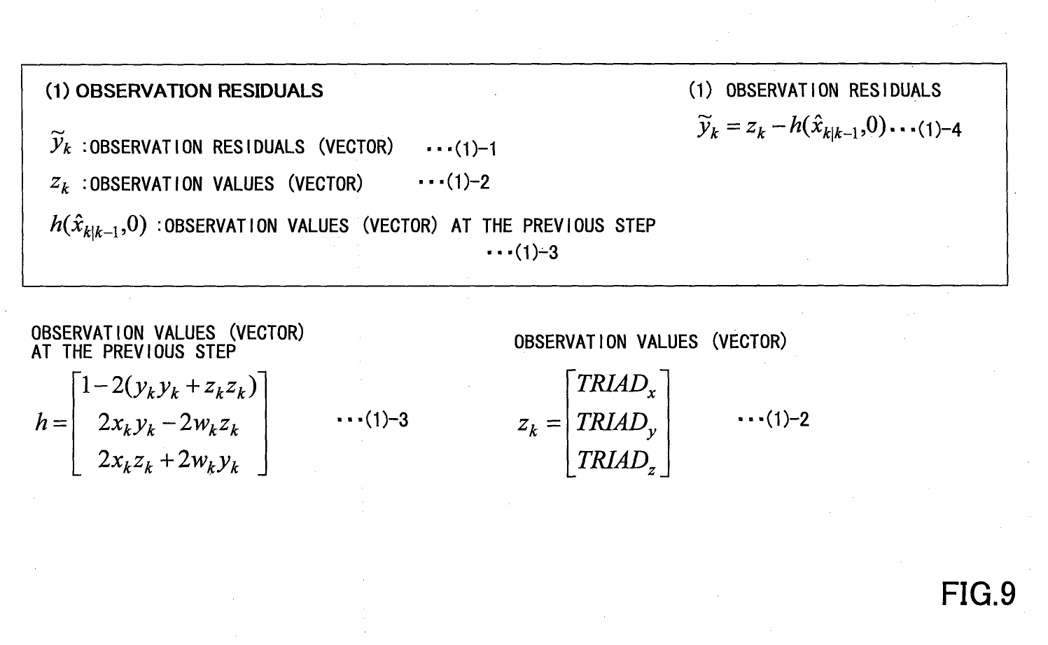

FIG. 9 is a drawing illustrating the second measurement update of the Extended Kalman Filter. The posture calculation unit 104 may receive a notification indicating that data obtained by the magnetic field acquisition unit 103 is reliable from the magnetic field reliability evaluation unit 105 (explained later). When the data from the magnetic field acquisition unit 103 is reliable, the posture calculation unit 104 may execute the second Measurement Update procedure using a yaw angle calculated from the posture data, which is obtained through the TRIAD algorithm, to correct the yaw angle component of the quaternion vector. The TRIAD algorithm is explained later.

FIG. 9 shows, in common with FIG. 8, variables included in observation residuals (1) in the general equation of the Extended Kalman Filter.

\tilde{y}ₖ

In common with FIG. 8, the observation values (vector) at the previous step h are represented as the equation (1)-3 in FIG. 9. On the other hand, the observation values (vector) zₖ are represented as the equation (1)-2 in FIG. 9.

$${z}_{k} = [ \begin{matrix}{TRIAD}_{x} \\ {TRIAD}_{y} \\ {TRIAD}_{z}\end{matrix} ]$$

The above vector indicates a yaw angle direction calculated by the TRIAD algorithm.

In common with the first Measurement Update procedure, the partial differential matrix (Jacobian) in the Measurement Update Hₖ in the general equation of the Extended Kalman Filter (2) is obtained by calculating the partial differential of the observation values at the previous step h.

The residual covariance Sₖ in the general equation of the Extended Kalman Filter (3) is calculated using the observation noise (matrix) Rₖ, the partial differential matrix in the Measurement Update Hₖ, its transposed matrix Hₖ^{T}, and the error covariance matrix at the present time P_{k|k-1}.

$${R}_{k} = [ \begin{matrix}{T}_{1} & 0 & 0 \\ 0 & {T}_{2} & 0 \\ 0 & 0 & {T}_{3}\end{matrix} ]$$

Here, the values (T₁, T₂, T₃) are variances which are determined in a device evaluation process for the magnetic field sensor 16 in advance.

In addition, the Kalman gain Kₖ (4), the updated state estimate values x_{k|k} (5), and the updated error covariance matrix P_{k|k} (6) are calculated in common with the first Measurement Update procedure.

The magnetic field reliability evaluation unit 105 may determine that the magnetic field vector acquired from the magnetic field sensor 16 via the magnetic field acquisition unit 103 is reliable, and the magnetic field reliability evaluation unit 105 may transmit the result to the posture calculation unit 104. It is known that the accuracy of the sensor data from the magnetic field sensor 16 may decrease depending on variation of the earth magnetism and environmental magnetic field surrounding the sensor device. The magnetic field reliability evaluation unit 105 may evaluate the effect and determine that the sensor data is reliable or not. In the following, the determination process is explained.

The magnetic field reliability evaluation unit 105 obtains first posture data (quaternion) which is the latest posture data which has been acquired via the above mentioned procedure. Next, the magnetic field reliability evaluation unit 105 acquires second posture data (quaternion) using reference vectors of the acceleration and the earth magnetism and magnetic field vectors obtained by the magnetic field acquisition unit 103 according to the TRIAD algorithm. The reference vectors of the acceleration and the earth magnetism representing the vertical downward direction are factory-configured or configured by the user.

### Calculation of a Posture Using TRIAD Algorithm

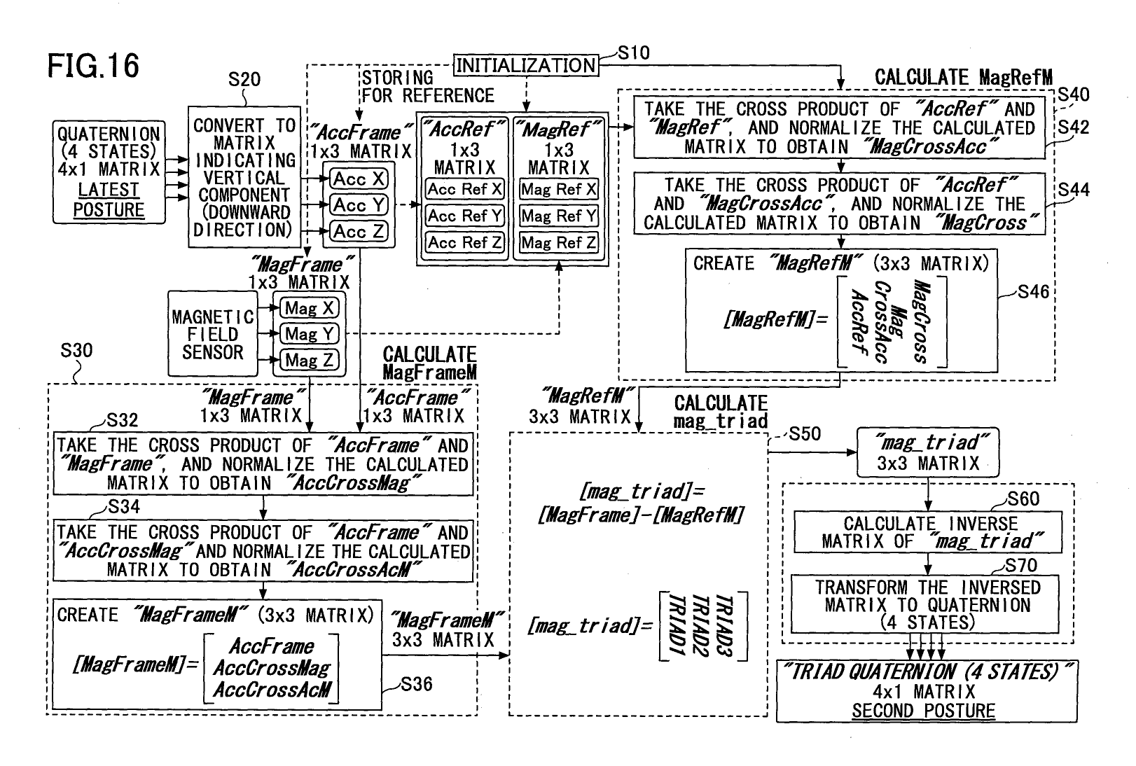

FIG. 16 is a drawing illustrating a procedure, which is performed by the magnetic field reliability evaluation unit 105, to calculate the second posture data according to the known TRIAD algorithm.

At step S10, an initialization process is performed before the device is shipped or in response to a user's instruction, and reference vectors AccRef and MagRef are stored. The AccRef indicates the vertical downward component of acceleration, and the MagRef is a magnetic field vector. The vector indicating the vertical downward component of acceleration may be calculated from the quaternion as explained at the following step S20. The magnetic field vector points to the compass north input from the magnetic field sensor. That step is only performed before the device is shipped or in response to a user's instruction. Thus, the reference vector keeps the same values unless the initialization process is executed.

At step S20, the magnetic field reliability evaluation unit 105 converts the latest quaternion vector (4×1) indicating the latest posture of the inertial device 1 into a 1×3 (i.e. 1 row, 3 columns) matrix AccFrame indicating the vertical component (downward direction).

At step S30, the magnetic field reliability evaluation unit 105 calculates a 3×3 matrix MagFrameM using the AccFrame and a matrix MagFrame indicating a magnetic field vector acquired by the magnetic field sensor.

At step S32, the magnetic field reliability evaluation unit 105 calculates a matrix AccCrossMag by taking the cross product of the AccFrame and the MagFrame and normalizing the calculated result.

At step S34, the magnetic field reliability evaluation unit 105 calculates a matrix AccCrossAcM by taking the cross product of the AccFrame and the AccCrossMag and normalizing the calculated result.

At step S36, the magnetic field reliability evaluation unit 105 calculates a 3×3 matrix MagFrameM by using the AccFrame, the AccCrossMag calculated at step S32, and the AccCrossAcM calculated at step S34.

At step S40, the magnetic field reliability evaluation unit 105 calculates a 3×3 matrix MagRefM using the AccRef and the MagRef.

At step S42, the magnetic field reliability evaluation unit 105 calculates a matrix MagCrossAcc by taking the cross product of the AccRef and the MagRef and normalizing the calculated result.

At step S44, the magnetic field reliability evaluation unit 105 calculates a matrix MagCross by taking the cross product of the AccRef and the MagCrossAcc and normalizing the calculated result.

At step S46, the magnetic field reliability evaluation unit 105 creates a 3×3 matrix MagRefM by combining the AccRef, the MagCrossAcc calculated at step S42, and the MagCross calculated at step S44, which are transposed respectively.

Step S40 (S42-S46) may be performed when the AccRef and the MagRef are changed after the initialization. Thus, the magnetic field reliability evaluation unit 105 may re-use the stored MagRefM until initialization is performed again.

At step S50, the magnetic field reliability evaluation unit 105 acquires the inner product of the MagFrame and the MagRefM. The acquired matrix is called a “mag_triad” (3×3). The mag_triad is used to convert the device coordinate system to the absolute coordinate system. In the TRIAD algorithm, three columns are called TRIAD1, TRIAD2, and TRIAD3 respectively.

At step S60, the magnetic field reliability evaluation unit 105 inverts the mag_triad (a matrix for conversion between the absolute coordinate system and the device coordinate system) and converts the inverted mag_triad to the quaternion. The quaternion indicates the second posture data.

The magnetic field reliability evaluation unit 105 compares a differential value of the first posture data with a differential value of the second posture data calculated by the above-mentioned steps to determine if a difference exists. When there is no difference (i.e. the difference of the differential values is smaller than a threshold value), the magnetic field reliability evaluation unit 105 determines that the data (earth magnetism) acquired by the magnetic field sensor 16 is reliable.

In addition, the magnetic field reliability evaluation unit 105 may improve the accuracy of such an evaluation by using the following criteria:
whether the absolute value of the magnetic field vector is within a predetermined range;
whether depression acquired from the first posture data and the magnetic field vector is within a predetermined range; and
whether depression acquired from the second posture data and the magnetic field vector is within a predetermined range.
   The range may be defined using depression data and amplitude of the magnetic field vector issued by the Japan Geographical Survey Institute.

When the earth magnetism data is reliable, the second Measurement Update procedure is executed using the yaw angle calculated from the second posture data. Otherwise, the second Measurement Update procedure is not executed.

The absolute acceleration conversion unit 107 multiply the acceleration obtained by the acceleration acquisition unit 101 by the inverse rotation matrix 106 calculated by the posture calculation unit 104 to calculate three axis acceleration in the absolute coordinate system.

### 3.2 Estimation for Travelling Direction

Direction estimation unit 200 as shown in FIG. 3, which executes the “Estimation for Travelling Direction” function, includes a band-pass filter 201, a peak detection unit 204, a peak position storage unit 205, a converted acceleration storage unit 206, a horizontal component of the converted velocity management unit 207, a vertical component of peak converted acceleration management unit 208, a horizontal component of the converted velocity acquisition unit 209, a cycle acquisition unit 210, a determination unit 211, and a direction calculation unit 212.

The direction estimation unit 200 may calculate a traveling direction of the target for each step based on acceleration obtained by the coordinate system conversion unit 100 in the absolute coordinate system.

The band-pass filter 201 may remove a gravity component from the three axis absolute acceleration output by the coordinate system conversion unit 100. For example, a passband may be about 1-3 Hz which is a general frequency for a walking motion. Note that the passband may vary depending on a frequency for a walking or traveling motion of the target of the inertial device 1. Here, the absolute acceleration in which the gravity component is removed is called a “converted acceleration 202”, which is output by the band-pass filter 201. The converted acceleration 202 may be stored in the converted acceleration storage unit 206. In addition, a vertical component of the converted acceleration is represented as a “vertical component of converted acceleration 203”. The vertical component of converted acceleration 203 is conveyed to the peak detection unit 204 (explained later).

The peak detection unit 204 may measure the variation (time variation) at the vertical component of converted acceleration 203 of the converted acceleration 202 output by the band-pass filter 201 and detect a lower turning point (peak time or peak positions) of the waveform. The detected peak position is stored in the peak position storage unit 205 (explained later). In the following, a detection method for the lower turning point is explained.

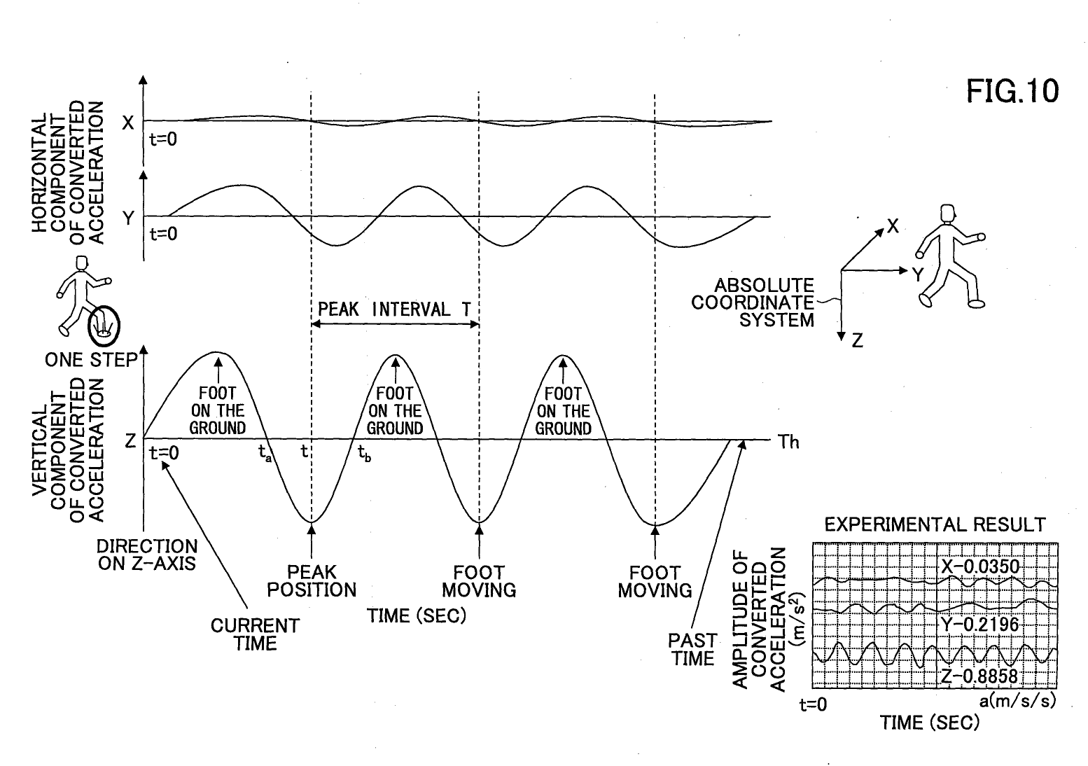

FIG. 10 shows waveforms indicating variation of the vertical component of converted acceleration 203 (Z) and the horizontal component of the converted acceleration (X, Y) where the abscissa axis indicates time (second). As shown in FIG. 10, each waveform has a cycle corresponding to the moving cycle (e.g. the walking cycle). In particular, the waveform of the vertical component of converted acceleration 203 has a bigger amplitude (from −1 m/s² to 1 m/s²) compared to the horizontal component. The upper turning point appears when a foot of the target touches the ground. The lower turning point appears when one foot passes the other foot.

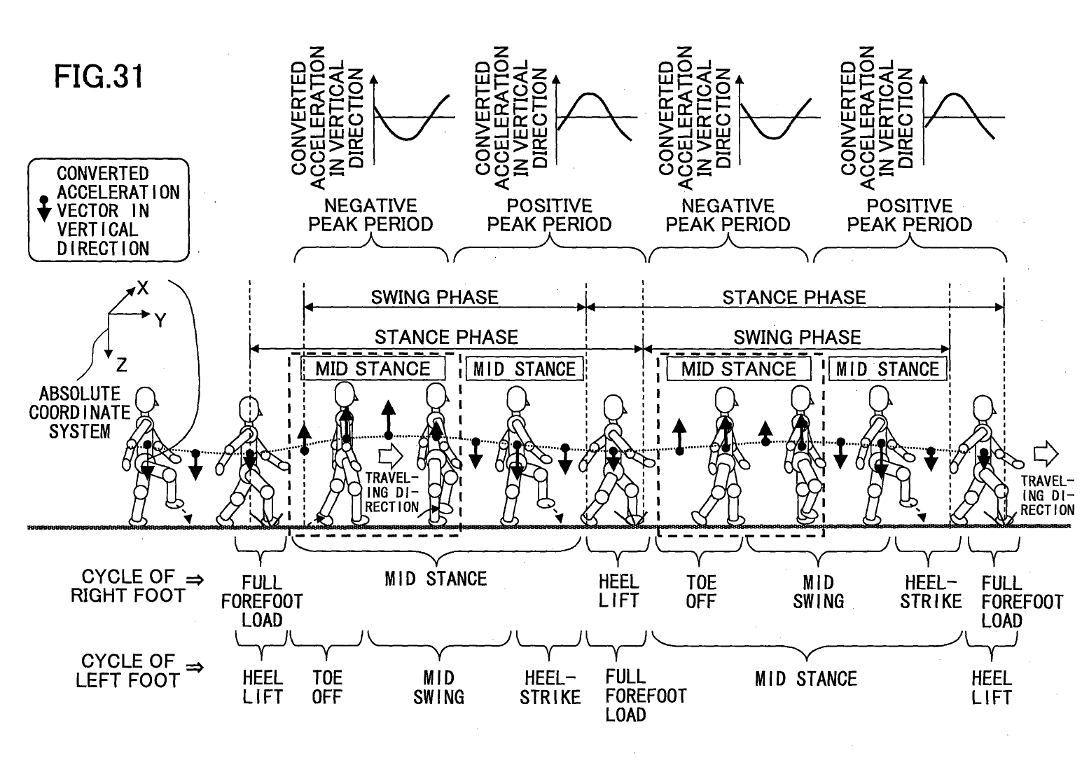

FIG. 31 is a drawing illustrating motion characteristics for walking in the vertical direction. In general, a walking motion may be categorized by a stance phase and a swing phase according to an inferior limb motion. In the stance phase, a heel of one foot touches the ground and then the toe of the foot rises off the ground. In the swing phase, a toe of one foot rises off the ground and then the heel of the foot touches the ground. In addition, the walking motion is characterized by double supporting period. In general, when the walking motion becomes slow, the rate of the double supporting period increases, and when the walking motion becomes fast, the rate decreases. In addition, a running motion eliminates the double supporting period. Furthermore, when the user walks straight, it is known that the movement in the vertical direction and horizontal direction is the greatest in a “mid stance” phase.

A first half of the mid stance phase includes a motion in which a lifting foot passes the pivoting foot (a lifting foot passes a point under the trunk at the body). The body moves toward the upper direction, and the converted acceleration occurs at the vertical upper direction. On the other hand, the last half of the mid stance phase includes a motion in which the lifting foot touches the ground. The body moves toward the lower direction, and the converted acceleration occurs at the vertical lower direction.

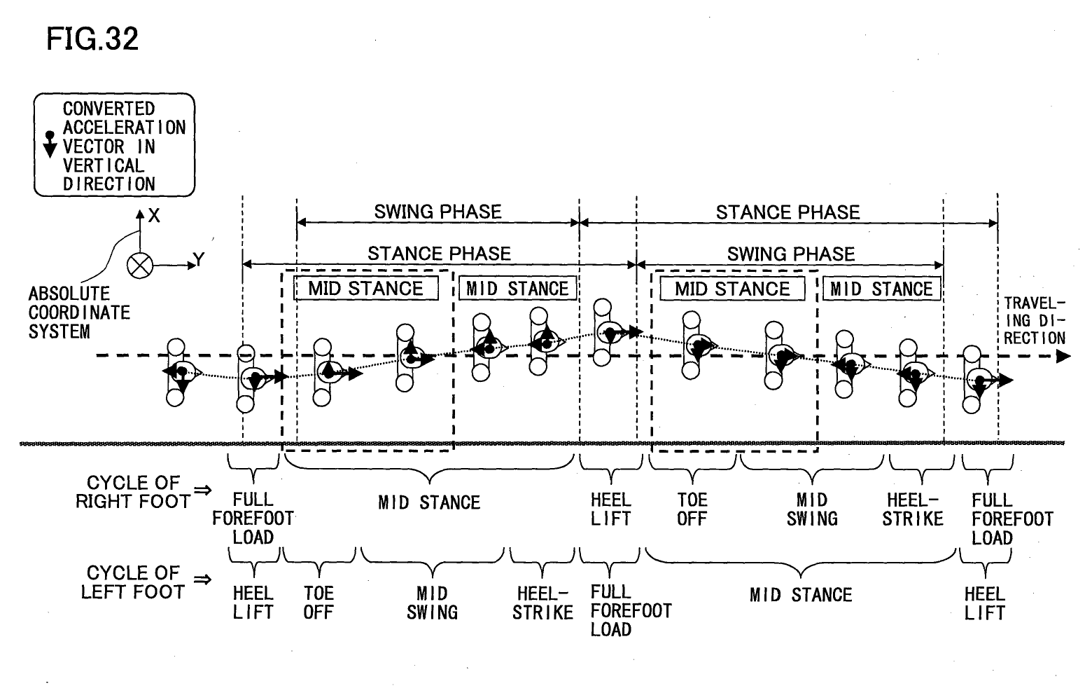

FIG. 32 is a drawing illustrating motion characteristics for walking in the horizontal direction. The horizontal component of the converted acceleration in the first half of the mid stance phase is affected by acceleration when a foot is lifted for a movement to a target position; and acceleration due to swaying caused by a movement of the center of gravity. On the other hand, the horizontal component of the converted acceleration in the last half of the mid stance phase is affected by acceleration when a foot is lifted for a movement to a target position; and acceleration due to swaying caused by a movement of the center of gravity. Thus, in the last half of the mid stance phase, the converted acceleration required to lift the foot is not observed.

Accordingly, the inertial device 1 according to an embodiment of this invention may estimate a traveling direction using the converted acceleration in the first half of the mid stance phase which reflects acceleration for lifting a foot to move the body of the target.

Thus, the inertial device 1 may detect, using signal thresholds, a lower turning point in the vertical component of converted acceleration 203 and measure a walking step. Since the converted acceleration in the horizontal direction at the upper turning point (i.e. a foot contacts the ground) is likely to include fluctuation and noise due to the contact, the lower turning point is used to detect the walking step. The converted acceleration in the horizontal direction at the lower turning point is less affected by the contact of the foot and may more precisely represent actual acceleration due to a walking motion.

The peak detection unit 204 may detect the peaks (the turning points) by detecting a moment at which the vertical component of converted acceleration 203 exceeds a predetermined threshold Th after the vertical component of converted acceleration 203 falls below Th. Here, the peak detection unit 204 may specify the peak position by calculating a middle time between the time tₐ when the vertical component of converted acceleration 203 falls below Th and the time t_{b} when the vertical component of converted acceleration 203 exceeds Th. For example, Th may be a half value of the vertical component of converted acceleration observed in an actual walking motion. Any other method may be used to detect the peak position.

In addition, by storing the past peak position, the peak detection unit 204 may calculate a peak interval indicating a time interval between the past peak position and the present peak position.

The peak position storage unit 205 may store the peak position detected by the peak detection unit 204. The peak position storage unit 205 stores the past peak and the latest peak positions using a ring buffer. The peak position storage unit 205 stores at least the latest peak position and the previous peak position. The peak positions are updated by peak positions obtained, later. The number of peak positions stored in the peak position storage unit 205 may be modified according to a storage capacity of the inertial device 1.

The converted acceleration storage unit 206 may add time data to the converted acceleration 202 output by the band-pass filter 201 and store them as time sequence data.

The horizontal component of the converted velocity management unit 207 may integrate, when the peak detection unit 204 detects the peak position, the horizontal component of the converted acceleration for each component (x and y) in a predetermined period (τ) centering on the peak position and calculate velocity in the horizontal direction. The velocity is called a “horizontal component of the converted velocity”. The horizontal component of the converted velocity is represented as a vector indicating a relative value of a direction and amplitude of the velocity. The horizontal component of the converted velocity management unit 207 may store a set of the horizontal component of the converted velocity and time t. Thus, the horizontal component of the converted velocity management unit 207 has a function to calculate the horizontal component of the converted velocity; and a function to store the horizontal component of the converted velocity.

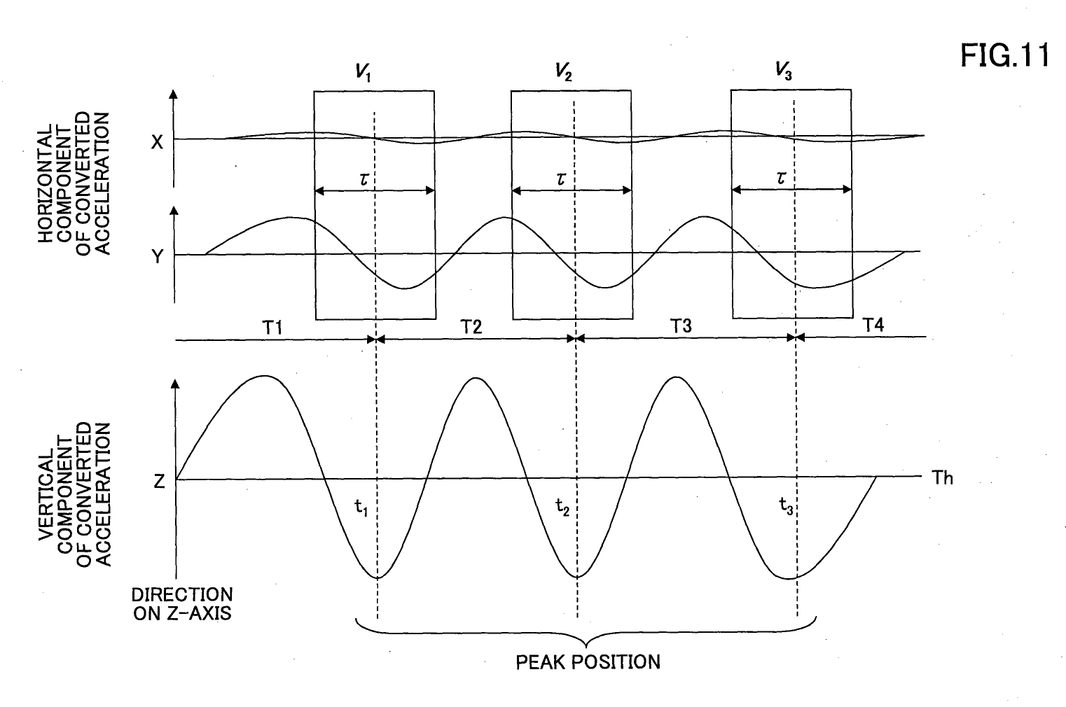

FIG. 11 shows waveforms indicating variation of the vertical component of converted acceleration 203 and the horizontal component of the converted acceleration, which correspond to the waveforms shown in FIG. 10. In this example, the horizontal component of the converted velocity management unit 207 may integrate the horizontal components of the converted acceleration with respects to time in predetermined periods (τ) centering on the peak positions t₁, t₂, and t₃ detected from the waveform of the vertical component of converted acceleration 203 and may calculate the horizontal component of the converted velocity V₁, V₂, V₃.

It is desirable that the period (τ) is less than or equal to (t_{b}-tₐ). This is because, if the horizontal component of the converted velocity management unit 207 performs the integration in the entire time domain, its result is likely to be affected by acceleration occurred by swaying due to a walking motion and acceleration occurred by fluctuation when a heel contacts the ground, and the horizontal component of the converted velocity management unit 207 fails to estimate the traveling direction correctly.

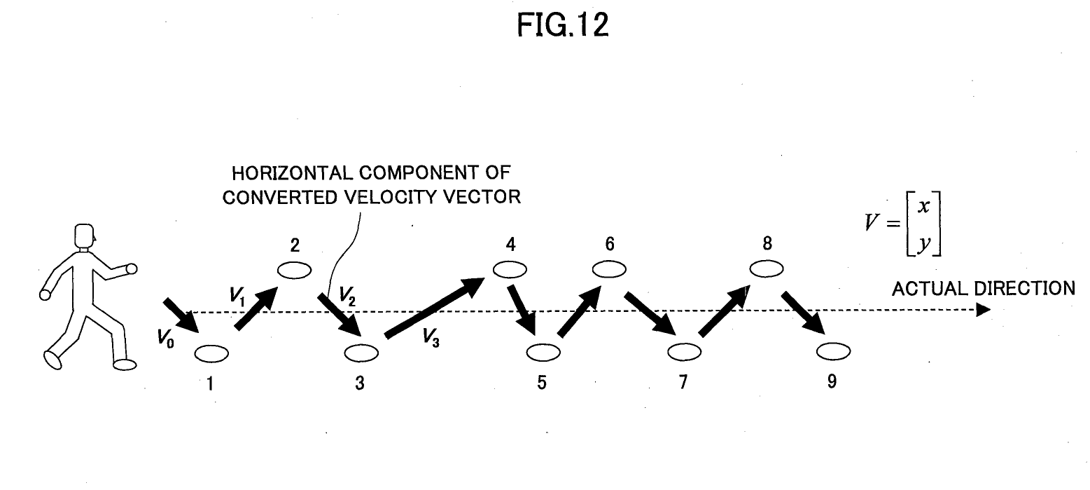

The horizontal component of the converted velocity may be generated by the above-mentioned peak detection procedure and the subsequent procedure when one foot passes the pivoting foot. The generated features may be represented as the horizontal component of the converted velocity vector indicating a direction and amplitude of the velocity. As shown in FIG. 12, the horizontal component of the converted velocity vector indicates the direction (traveling direction) and the amplitude of the movement of the target's body from side to side when one foot passes the pivoting foot.

The vertical component of peak converted acceleration management unit 208 may obtain converted acceleration at the peak position (time) in the vertical component of converted acceleration 203 (hereinafter called a “vertical component of the peak converted acceleration”), and may convey the converted acceleration to the determination unit 211 (explained later).

The horizontal component of the converted velocity acquisition unit 209 may obtain the latest and the previous horizontal components of the converted velocity from the horizontal component of the converted velocity management unit 207, and may convey the obtained horizontal component of the converted velocity to the determination unit 211.

The cycle acquisition unit 210 may obtain a plurality of the peak positions from the peak position storage unit 205 and obtain a traveling cycle (e.g. a walking cycle) of the target. In addition, the cycle acquisition unit 210 may obtain the latest and the past traveling cycle by calculating differences of the peak positions. The cycle acquisition unit 210 may pass the obtained traveling cycles to the determination unit 211 (explained later).

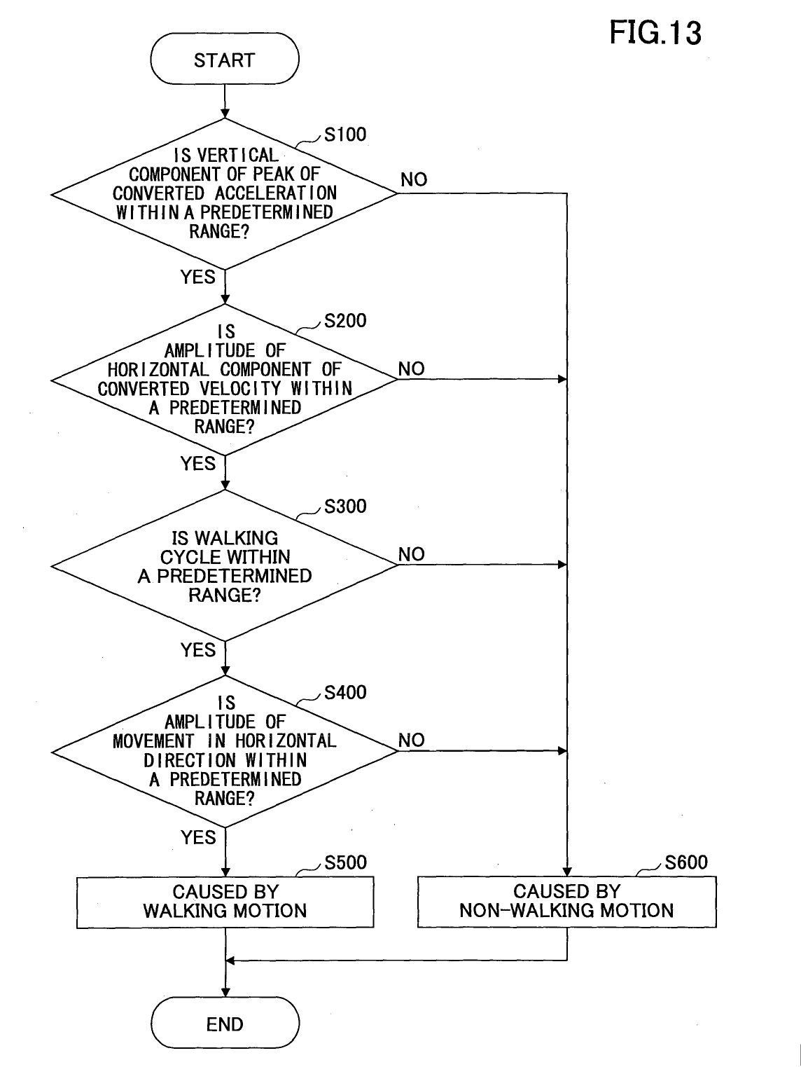

The determination unit 211 may determine that various kinds of data obtained in the above-mentioned procedure derive from an actual walking motion by executing procedures shown in FIG. 13. The walking motion includes a traveling motion performed by the target, which includes the walking motion as well as a running motion. On the other hand, a non-walking motion includes a motion to voluntary or involuntary shake the inertial device 1 or a motion caused by acceleration induced from an external environment (e.g. the target is transported by a traveling object). In the following, the procedure shown in FIG. 13 is explained.

At step S100, the determination unit 211 determines whether the vertical component of the peak converted acceleration obtained from the vertical component of peak converted acceleration management unit 208 falls within a predetermined range. If so, the procedure goes to step S200. Otherwise, the procedure goes to step S600 and the determination unit 211 determines that the detected motion (i.e. data) derives from a non-walking motion. The predetermined range about the vertical component of the peak converted acceleration may be pre-configured by a supplier or a user of the inertial device 1 according to the characteristics of the measurement target (e.g. the walking characteristics of the pedestrian).

Next, in step S200, the determination unit 211 determines whether the amplitude of the horizontal component of the converted velocity obtained from the horizontal component of the converted velocity management unit 207 falls within a predetermined range. If so, the procedure goes to step S300. Otherwise, the procedure goes to step S600 and the determination unit 211 determines that the detected motion derives from the non-walking motion. The predetermined range of the horizontal component of the converted velocity may be pre-configured by a supplier or a user of the inertial device 1 according to the characteristics of the measurement target (e.g. the walking characteristics of the pedestrian).

Next, in step S300, the determination unit 211 determines whether the traveling cycle obtained from the cycle acquisition unit 210 falls within a predetermined range. If so, the procedure goes to step S400. Otherwise, the procedure goes to step S600 and the determination unit 211 determines that the detected motion derives from a non-walking motion. The predetermined range of the traveling cycle may be pre-configured by a supplier or a user of the inertial device 1 according to the characteristics of the measurement target (e.g. the walking characteristics of the pedestrian).

Next, in step S400, the determination unit 211 determines whether the amplitude of the movement in the horizontal direction falls within a predetermined range. If so, the procedure goes to step S500. Otherwise, the procedure goes to step S600 and the determination unit 211 determines that the detected motion derives from a non-walking motion.

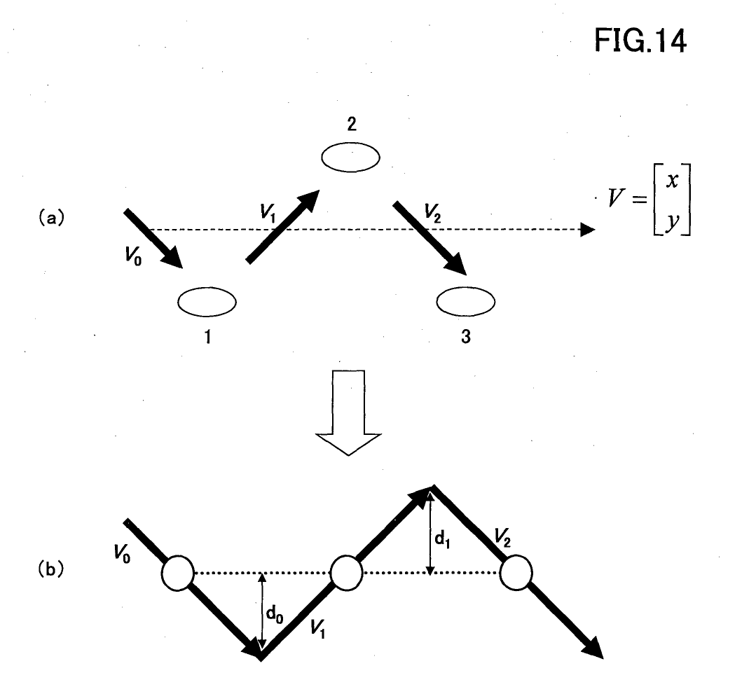

Here, with reference to FIG. 14, the variation of the velocity in the horizontal direction is explained. As shown in FIG. 14(a), in a walking motion, when the user steps forward with the right foot, the converted velocity vector occurs in the right direction, and when the user steps forward with the left foot, the converted velocity vector occurs in the left direction. In order to recognize that motion, the determination unit 211 determines that the horizontal component of the converted velocity vector meets those characteristics.

First, the determination unit 211 combines a start point of the horizontal component of the converted velocity vector and an end point of the horizontal component of the converted velocity vector as shown in FIG. 14(b). Next, the determination unit 211 calculates a distance dₙ between a line connecting centers of Vₙ vectors and the end point of each Vₙ vector. Next, the determination unit 211 determines whether dₙ falls within a predetermined range, and if so, the determination unit 211 determines that the motion derives from an actual walking motion. The predetermined range about dₙ may be pre-configured by a supplier or a user of the inertial device 1 according to the characteristics of the measurement target (e.g. the walking characteristics of the pedestrian).

At step S500, the determination unit 211 determines that the motion derives from an actual walking motion.

At step S600, the determination unit 211 determines that the detected motion derives from a non-walking motion.

Note that one or more steps of the above-mentioned steps S100 to S400 may be omitted. However, when all of the steps are executed, the inertial device 1 may estimate a traveling direction precisely.

When the determination unit 211 determines that the detected motion derives from a walking motion, the direction calculation unit 212 may perform the following procedure to estimate a traveling direction for each step.

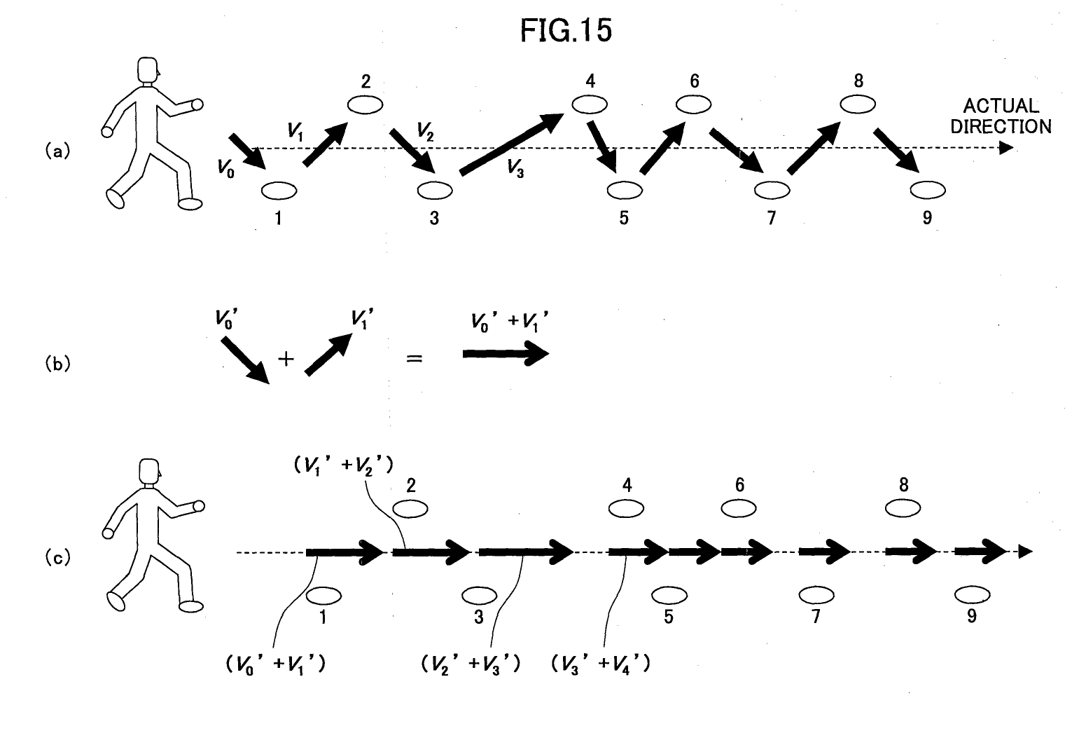

When a walking motion of a user transitions from zero steps to the first step, the direction calculation unit 212 obtains the horizontal component of the converted velocity vector V₀ from the horizontal component of the converted velocity acquisition unit 209 (See FIG. 15(a)). Next, when a walking motion of a user transitions from the first step to the second step, the direction calculation unit 212 obtains the horizontal component of the converted velocity vector V₁ from the horizontal component of the converted velocity acquisition unit 209 (See FIG. 15(a)).

Next, the direction calculation unit 212 normalizes the vectors V₀, V₁ to obtain vectors V₀′, V₁′. The direction calculation unit 212 calculate a resultant vector of the obtained vectors V₀′, V₁′, and estimates a traveling direction 213 for each step using a direction of the resultant vector. The above procedure is executed when the user moves forward a step.

As discussed above, the inertial device 1 may estimate a traveling direction per step by using a velocity vector in the horizontal direction in a time period centering on the (lower) peak position of the acceleration in the vertical direction in the absolute coordinate system. That may decrease an effect of vibration occurring when a foot of a pedestrian touches the ground while improving accuracy of the location estimation.

In addition, the inertial device 1 may evaluate accuracy of sensor data acquired from the magnetic field sensor. When the sensor data is reliable, the inertial device 1 may use the sensor data to correct a vector which represents the posture of the inertial device 1 (for a yaw angle component). As a result, the inertial device 1 may correct the vector representing the posture with a high degree of accuracy using the data from the magnetic field sensor.

### 4. Current Position Estimate Function

In the above discussion, it is explained that the inertial device 1 executes a function for estimating a traveling direction of a target based on outputs from inertial sensors. In the following, it will be explained that the inertial device 1 executes a function for estimating the current position of the target using the traveling direction and an absolute position acquired from an external means.

FIG. 17 is a block diagram of a functional configuration for the inertial device 1 according to an embodiment of this invention. The inertial device 1 according to this embodiment has a velocity estimate unit 300, an absolute positional data input unit 400, an absolute position estimate unit 500, and a map-matching unit 600 in addition to the coordinate system conversion unit 100 and the direction estimate unit 200 as discussed with FIG. 3. As shown in FIG. 17, input data for each functional unit and output data from each functional unit is illustrated schematically. In the following section, functions provided by the velocity estimate unit 300, the absolute positional data input unit 400, the absolute position estimate unit 500, and the map-matching unit 600 are discussed. As described hereinbelow, the velocity estimate unit 300 may calculate a velocity estimate vector which represents an actual velocity of the target based on a horizontal component of the converted velocity 214, a vertical component of peak acceleration 215, a cycle 216, an amplitude of body motion from side to side 217 (herein after called “amplitude 217”), and a traveling direction 213 (hereinafter called “direction 213”) which are calculated by the direction estimate unit 200.

### 4.1 Velocity Estimation

FIG. 18 illustrates a detailed functional block diagram for the velocity estimate unit 300. The velocity estimate unit 300 has a horizontal component of the converted velocity acquisition unit 301, a vertical component of peak acceleration management unit 302, a cycle acquisition unit 303, an amplitude acquisition unit 304, a direction acquisition unit 305, a conversion unit 306, a velocity waveform generation unit 312, a velocity waveform combination unit 314, and a velocity waveform storage unit 315. The velocity estimate unit 300 may calculate the velocity estimate vector which represents the actual velocity of the target based on the horizontal component of the converted velocity 214, the vertical component of peak acceleration 215, the cycle 216, the amplitude 217, and the direction 213. In the following, processing executed by the velocity estimate unit 300 is discussed.

The horizontal component of the converted velocity acquisition unit 301 may acquire the horizontal component of the converted velocity 214 from the horizontal component of the converted velocity management unit 207 similarly to the horizontal component of the converted velocity acquisition unit 209 of the direction estimate unit 200, and the horizontal component of the converted velocity acquisition unit 301 may input the horizontal component of the converted velocity 214 to the conversion unit 306.

The vertical component of peak acceleration management unit 302 may acquire the vertical component of peak acceleration 215 from the converted acceleration storage unit 206 similarly to the vertical component of peak moving acceleration management unit 208 of the direction estimate unit 200, and the vertical component of peak acceleration management unit 302 may input the vertical component of peak acceleration 215 to the conversion unit 306.

The cycle acquisition unit 303 may acquire the cycle 216 of motion for the target using data stored in the peak position storage unit 205 similarly to the cycle acquisition unit 210 of the peak position storage unit 205, and the cycle acquisition unit 303 may input the acquired data to the conversion unit 306.

The amplitude acquisition unit 304 may acquire the amplitude 217, which represents the degree of movement of the target from side to side, from the horizontal component of the converted velocity 214, and the amplitude acquisition unit 304 may input the amplitude 217 to the conversion unit 306. The amplitude 217 may be calculated as illustrated above using FIG. 14.

The direction acquisition unit 305 may acquire the direction 213 from the direction calculation unit 212 of the direction estimate unit 200 and input the direction 213 to the conversion unit 306.

The conversion unit 306 may convert the horizontal component of the converted velocity 214, the vertical component of peak acceleration 215, the cycle 216, the amplitude 217, and the direction 213 into a velocity parameter Pa 307, an intensity parameter Pb 308, a cycle parameter Pc 309, an amplitude parameter Pd 310, and a direction parameter Pe 311, respectively. The conversion unit 306 may normalize the data 214-217 according to a predetermined rule. The conversion unit 306 may convert each data into the parameter normalized in a certain range using any known normalization method.

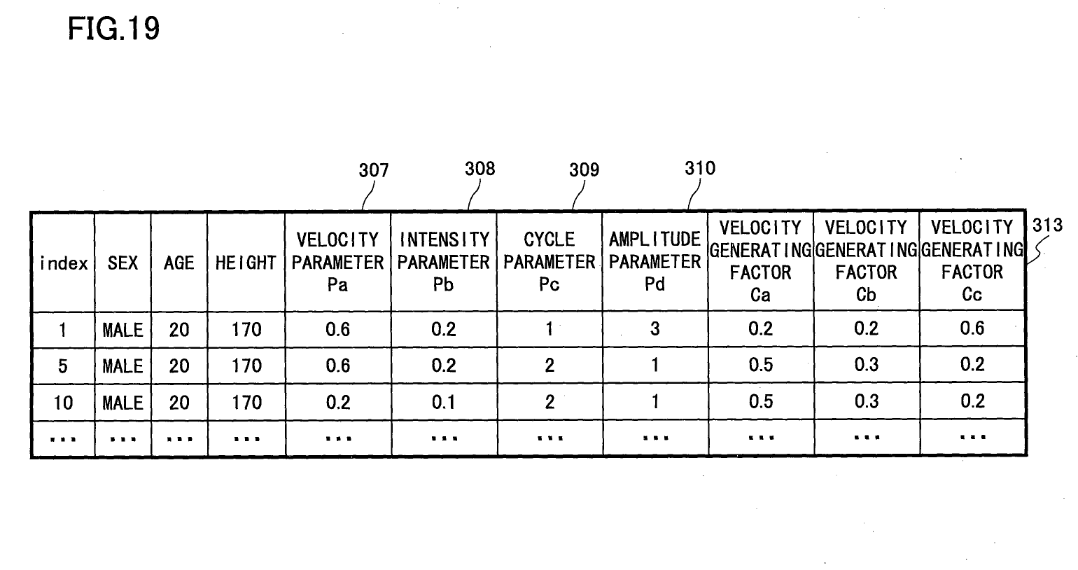

The velocity waveform generation unit 312 may refer to a parameter DB 313 as shown in FIG. 19 and specify velocity generating factors Ca-Cc using one or more of the input parameters 307-311 (the input parameters 307-310 are used in the example shown in FIG. 19) and given attributes of the target (such as “sex”, “age”, and “height” of the target) as a key. Next, the velocity waveform generation unit 312 may generate a velocity waveform using one or more of the input parameters 307-311 and the velocity generating factors Ca-Cc according to an equation described below.

Here, the attributes may include “sex”, “age”, and “height” of the target. The attributes include, but are not limited to, any other information about the target such as a type of the target (e.g. a human, an animal, and a biped robot), an identification number, a serial number, and motion speed (e.g. high speed or low speed).

As shown in FIG. 19, the parameter DB 313 associates the attributes of the target “sex”, “age”, and “height” with the parameters 307-310 and the velocity generating factors Ca-Cc. In the example shown in FIG. 19, the direction parameter 311 is not used to specify the velocity generating factors Ca-Cc (i.e. the velocity generating factors are specified regardless of the direction). However, the parameter DB 313 may include the direction parameter 311 to specify the velocity generating factors Ca-Cc.

The parameter DB 313 is created in advance based on data acquired by an experiment in which a group of targets having common attributes performs motion determined by the parameters 307-311. Here, the parameter DB 313 maintains a norm value of the velocity parameter Pa.

When an entry having the input parameters 307-311 does not exist in the parameter DB 313, the velocity waveform generation unit 312 may choose the velocity generating factors Ca-Cc associated with other parameters 307-311 which are close to the input parameters. For example, for the purpose of choosing such factors (i.e. an entry including other parameters 307-311 which are close to the input parameters), the velocity waveform generation unit 312 may choose one of entries in which a sum of root-mean-square (RMS) of the parameters is the smallest. Any other known method may be used to choose the corresponding entry in the parameter DB 313. The velocity waveform generation unit 312 may transmit the specified velocity generating factors Ca-Cc to the velocity waveform combination unit 314.

The velocity waveform generation unit 312 may generate a velocity waveform representing variation of velocity of the target in a time period 0<=<=Pc using the velocity generating factors Ca-Cc and the input parameters Pa-Pe 307-311 in the following equation.

$${Ve}_{x} = ( {P}_{a} {C}_{a} + {P}_{b} {C}_{b} + {P}_{d} {C}_{c} ) sin ( \frac{π}{{P}_{C}} t ) cos θ$$

$${Ve}_{y} = ( {P}_{a} {C}_{a} + {P}_{b} {C}_{b} + {P}_{d} {C}_{c} ) sin ( \frac{π}{{P}_{C}} t ) cos θ$$

Alternatively, the velocity waveform generation unit 312 may generate any other equation to generate the velocity waveform.

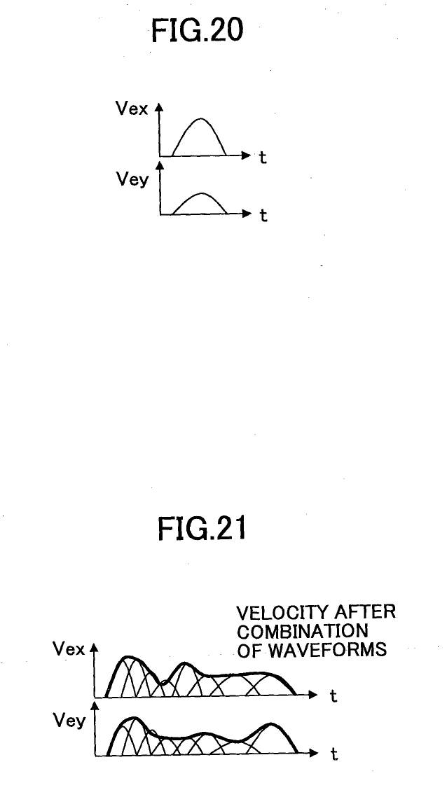

FIG. 20 shows an example of the generated velocity waveform. Here, θ corresponds to the direction parameter Pe 311. The equation 14 includes three members: the first member to estimate velocity based on the velocity parameter Pa 307, the second member to estimate velocity based on the intensity parameter Pb 308, and the third member to estimate velocity based on the amplitude parameter Pd 310. The parameters Pa, Pb, and Pd in the members are multiplied by the velocity generating factors Ca-Cc, respectively. As a result, the velocity waveform representing walking motion is generated with high accuracy due to the velocity estimation based on a plurality of the parameters. Here, the velocity generating factors Ca-Cc stored in the parameter DB 313 are normalized so that the sum of them equals to 1. The velocity waveform generation unit 312 may transmit the generated velocity waveform to the velocity waveform combination unit 314.

After receiving the velocity waveform from the velocity waveform generation unit 312, the velocity waveform combination unit 314 may read the past velocity waveforms which have been previously generated and stored in the velocity waveform storage unit 315, and the velocity waveform combination unit 314 may combine them. The velocity waveform combination unit 314 may combine the velocity waveforms by multiplying the velocity waveforms on a time axis. The velocity waveform combination unit 314 may combine the velocity waveforms in any known method. For example, the velocity waveform combination unit 314 may plot the maximum value of two or more of the velocity waveforms at a given time in order to create a single combined waveform. FIG. 21 shows an example of the velocity waveform combined by the velocity waveform combination unit 314. The velocity waveform combination unit 314 may store the combined waveform in the velocity waveform storage unit 315.

The velocity waveform storage unit 315 may store the velocity waveform combined by the velocity waveform combination unit 314 as well as time information.

In this way, the velocity waveform storage unit 315 may store the latest velocity waveform combined according to the parameters which are obtained as needed. The absolute position estimate unit 500 and the map-matching unit 600, which are discussed later, may obtain velocity data representing the latest velocity by referring to values of the combined velocity waveform at the present time. The velocity data may be represented by two components in the horizontal direction. Thus, the velocity data is called “velocity estimate vector 316”.

### 4.2 Absolute Positional Data Input

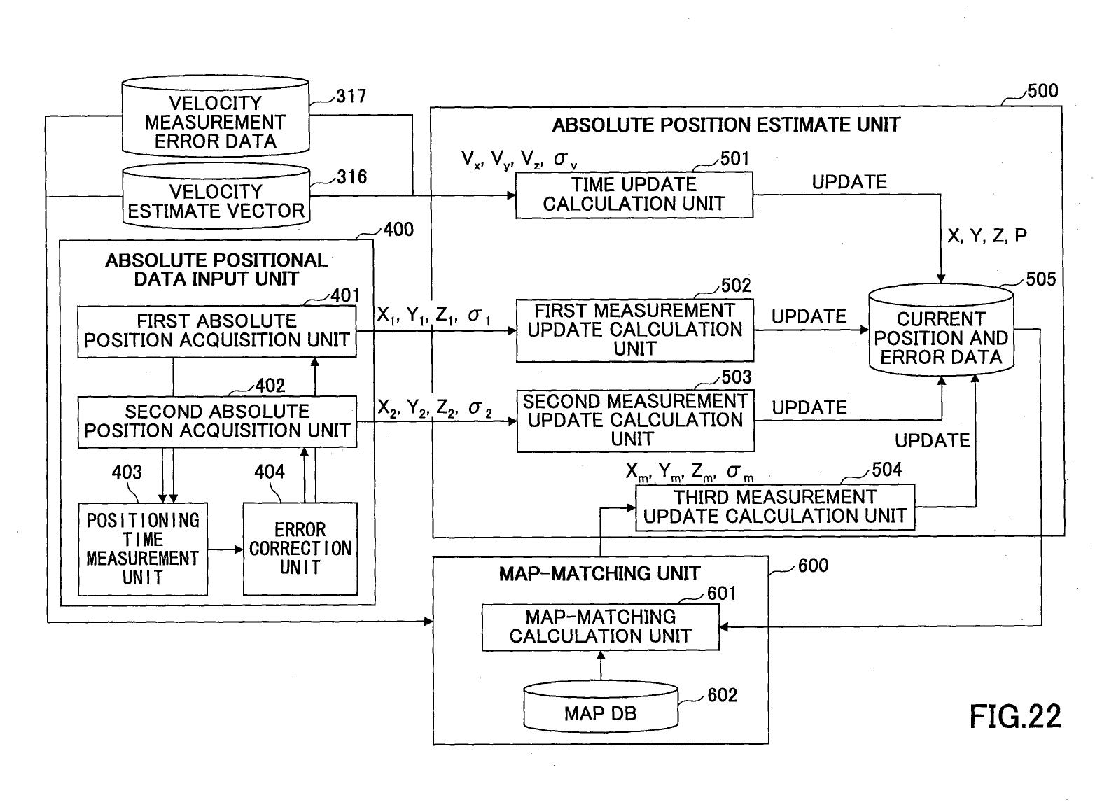

FIG. 22 illustrates a detailed functional block diagram for the absolute positional data input unit 400, the absolute position estimate unit 500, and the map-matching unit 600.

The absolute positional data input unit 400 includes a first absolute position acquisition unit 401, a second absolute position acquisition unit 402, a positioning time measurement unit 403, and an error correction unit 404. The absolute positional data input unit 400 may input absolute positional data representing an absolute position of the inertial device 1 and error data representing the degree of the error of the positional data to the absolute position estimate unit 500.

The first absolute position acquisition unit 401 may communicate with an external device such as a positional data transmitter via Bluetooth™ communications to obtain the absolute positional data representing the absolute position of the inertial device 1. The absolute positional data may include a set of positional vectors X1, Y1, and Z1 which represents the degree of latitude, longitude, and altitude. Alternatively, the absolute positional data may include any vector representing a relative position from the predetermined base point. The first absolute position acquisition unit 401 may acquire the error data σ1 representing the degree of error of the absolute positional data from the positional data transmitter. The error data σ1 is an error covariance matrix about the absolute positional data acquired from the positional data transmitter. For example, the error data σ1 includes error values which are determined according to the radio field strength on the communication between the positional data transmitter and the inertial device 1. For example, when the ratio field strength is weaker, the error covariance matrix indicates that the absolute positional data is less accurate. The error data may be stored in the inertial device 1 in advance or transmitted by the positional data transmitter. The first absolute position acquisition unit 401 may transmit the absolute positional data (e.g. the positional vectors) and the error data to a first measurement update calculation unit 502 of the absolute position estimate unit 500 which is discussed later.

The second absolute position acquisition unit 402 may acquire absolute positional data X2, Y2, and Z2, and error data σ2 via a different means from the first absolute position acquisition unit 401 such as GPS or Indoor Messaging System (IMES). In another embodiment, the second absolute position acquisition unit 402 may be omitted (i.e. only the first absolute position acquisition unit 401 exists). The number of the absolute position acquisition unit may be determined based on a system to which the inertial device 1 is applied. The second absolute position acquisition unit 402 may transmit the absolute positional data (the positional vectors) and the error data to a second measurement update calculation unit 503 of the absolute position estimate unit 500.

The positioning time measurement unit 403 may measure time intervals in which the first absolute position acquisition unit 401 and the second absolute position acquisition unit 402 acquire the absolute positional data and transmit them to the error correction unit 404 discussed below.

The error correction unit 404 may determine whether the time intervals transmitted by the positioning time measurement unit 403 correspond to a predetermined interval. According to the width of the interval, the error correction unit 404 may modify the error covariance matrix (σ1 or σ2) output from each the respective position acquisition unit 401 or 402 so that the covariance value becomes higher. To achieve that, the error correction unit 404 may use a table which associates the interval (sec) with an amount of correction (a value to be multiplied by the covariance value). Alternatively, the error correction unit 404 may correct the error covariance matrix when the interval exceeds a threshold value.

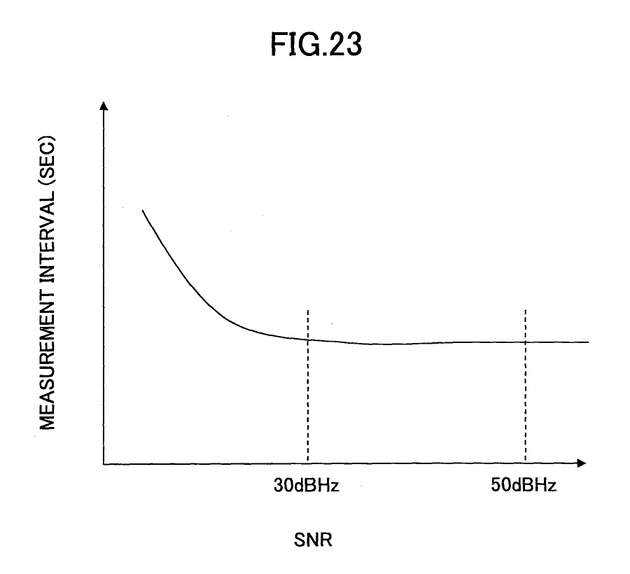

Since the error data derived from the GPS or the IMES is not generated on the ground of a multipath effect, the degree of accuracy for the error data depends on radio wave conditions. FIG. 23 shows a relationship between a signal-to-noise ratio (SNR) and the duration of a measurement interval. Thus, when the measurement interval exceeds the predetermined duration, the error correction unit 404 may correct the error covariance so that the covariance values become higher; and thereby the variation of the degree of the accuracy may be reduced.

The external device such as the positional data transmitter may transmit the absolute positional data and the error data via infrared communications, wireless LAN communications, or visible light communications, or positioning means with a camera, etc. The inertial device 1 may receive the absolute positional data and the error data by using a receiving unit configured to receive a signal via the above-mentioned communications. The received absolute positional data and the error data may be input to the measurement update calculation unit (502 or 503) of the absolute position estimate unit 500 (discussed later). Any number of the sets of the absolute position acquisition unit and the measurement update calculation unit may be employed depending on a system to which the inertial device 1 is applied.

### 4.3 Absolute Position Estimation

The absolute position estimate unit 500 includes a time update calculation unit 501, the first measurement update calculation unit 502, the second measurement update calculation unit 503, and a third measurement update calculation unit 504.

The absolute position estimate unit 500 may estimate the current position and error data (hereinafter called “current position and error data 505”) using the velocity estimate vector 316 and the velocity measurement error data 317 provided with the velocity estimate vector 316. The velocity measurement error data 317 is an error covariance matrix σv representing an error of the velocity estimate vector 316. The velocity measurement error data 317 is determined and fixed by a system identification of the inertial device 1. Alternatively, a plurality of error covariance matrices may be used according to the velocity.

In addition, the absolute position estimate unit 500 may update the current position and error data 505 using the absolute positional data (the positional vectors) and error data (the error covariance matrix) output from the absolute positional data input unit 400. In addition, the absolute position estimate unit 500 may update the current position and error data 505 by using positional data (positional vectors) and error data (an error covariance matrix) output from the map-matching unit 600.

The absolute position estimate unit 500 may calculate or update the current position and error data 505 with the Extended Kalman Filter. In this embodiment, the absolute position estimate unit 500 may execute a time update procedure (time update calculation unit 501) and three measurement update procedures (the first, second, and third measurement update calculation units 502, 503, and 504) in parallel. Variables and models used in the procedures are explained below.

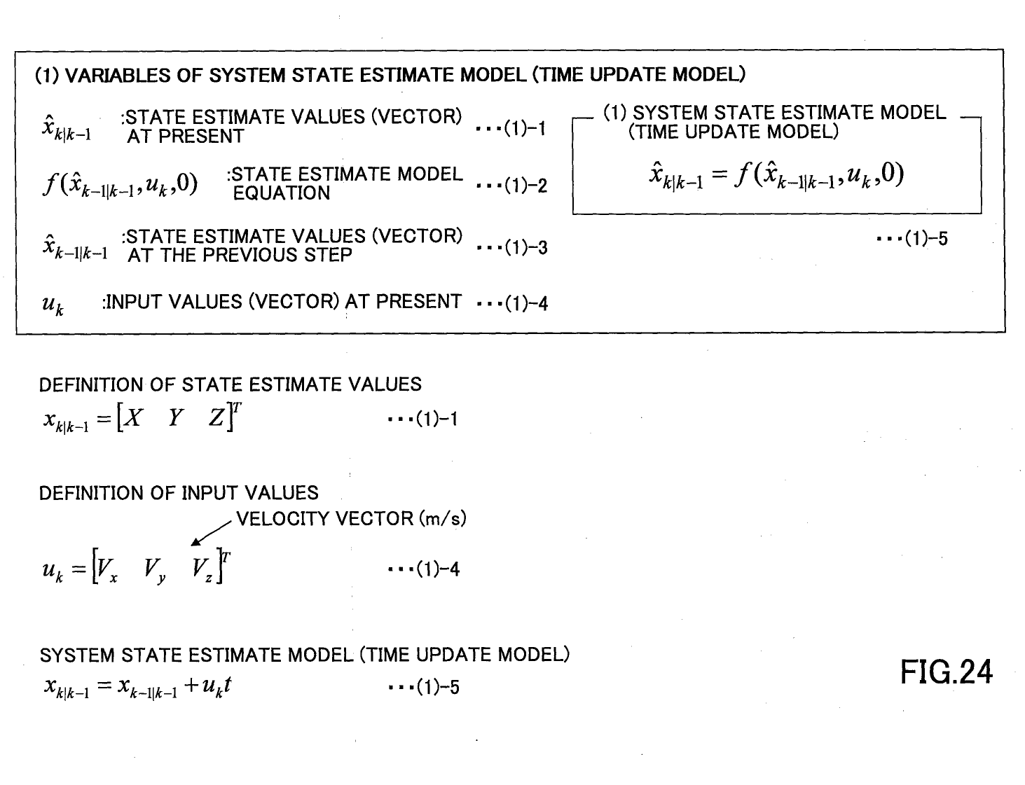

The time update calculation unit 501 may execute the time update procedure in the Extended Kalman Filter according to the definition of the variables and the models as shown in FIGS. 24-26 and calculate or update the current position and error data 505 of the inertial device 1. The variables and the model in the Extended Kalman Filter are defined as shown in FIG. 24. Thus, the state estimate values at present may be represented by a three dimension positional vector (i.e. the equation (1)-1 as shown in FIG. 24). In addition, the input values at present may be defined using the velocity estimate vector 316 (i.e. the equation (1)-4 as shown in FIG. 24) output from the velocity estimate unit 300. Furthermore, the system state estimate model may be defined as the equation (1)-5 as shown in FIG. 24.

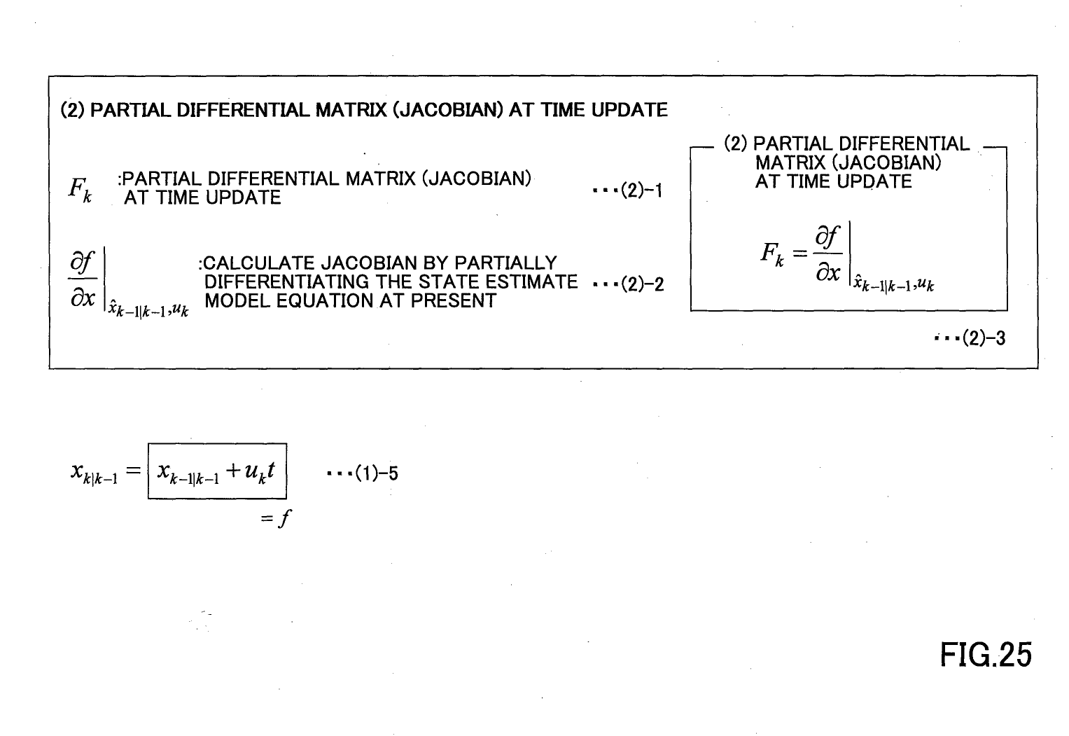

As shown in FIG. 25, the partial differential matrix (Jacobian) is the partial differentiation on the right side of the system state estimate model.

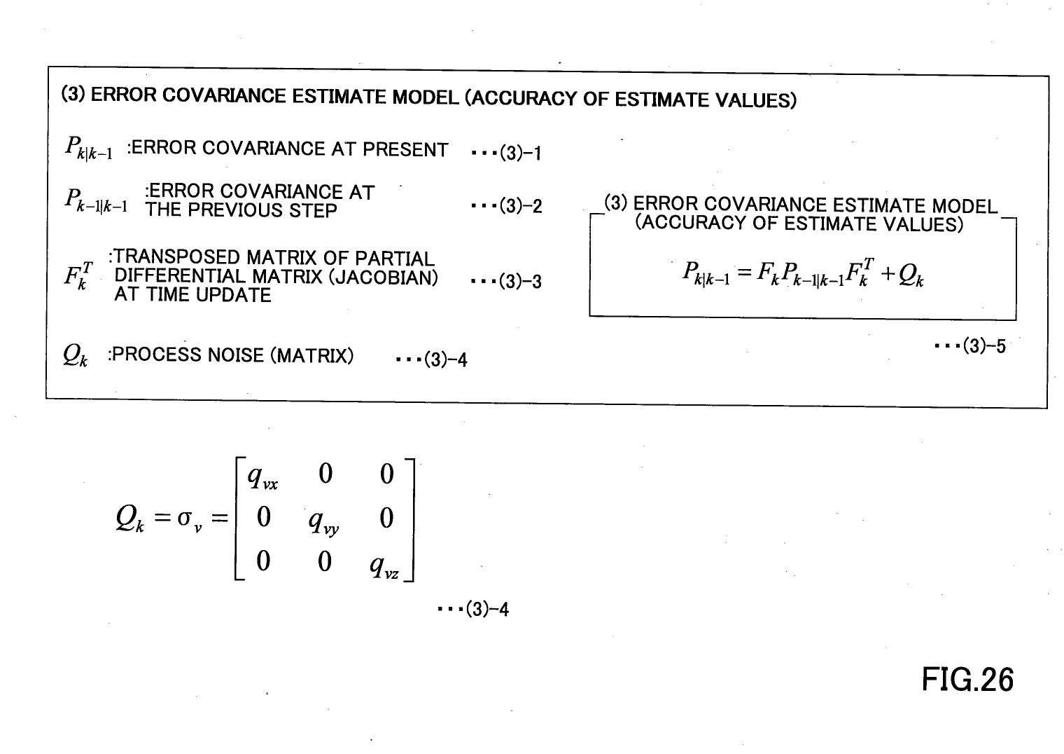

As shown in FIG. 26, the process noise Qk is the velocity measurement error data 317 which is predetermined and fixed (i.e. constant) by the system identification. An error covariance matrix at present P_{k|k-1} and P_{k-1|k-1} are 3×3 matrices in which all of the elements are real number.

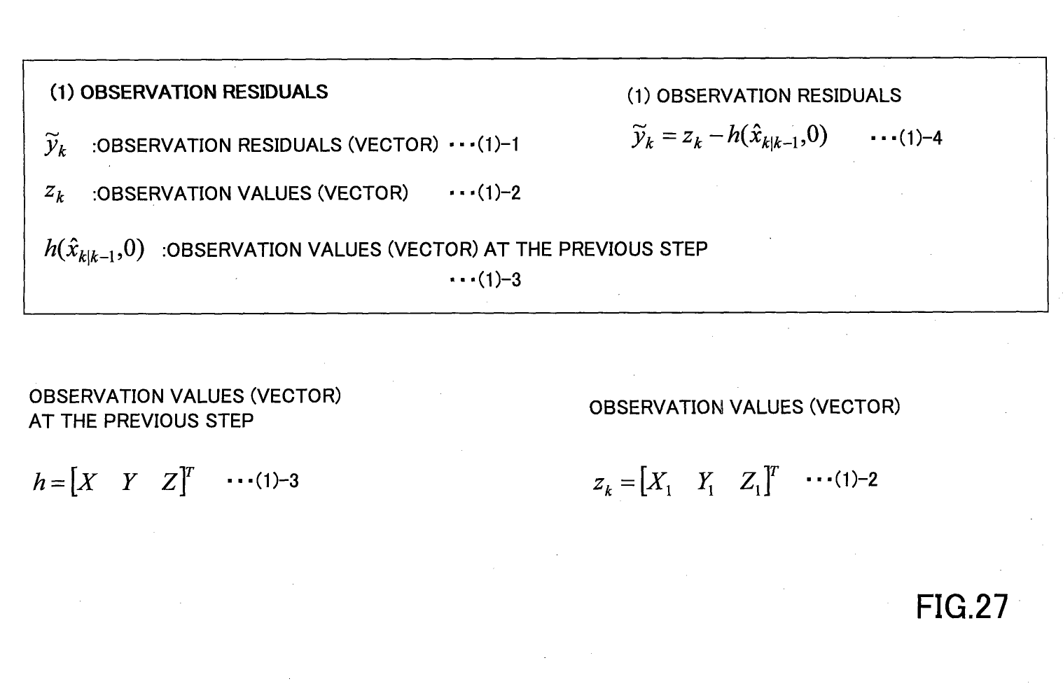

The first measurement update calculation unit 502 may execute the measurement update of the Extended Kalman Filter and calculate or update the current position and error data 505 of the inertial device 1. The variables and the model in the Extended Kalman Filter are defined as shown in FIG. 27. Thus, the observation values at the previous step may be represented by a three dimension positional vector (i.e. the equation (1)-3 as shown in FIG. 27). In addition, the observation values are the positional vector (i.e. the absolute positional data) output from the first absolute position acquisition unit 401 (i.e. the equation (1)-2 as shown in FIG. 27).

\tilde{y}ₖ

Based on h and zₖ, the following observation residuals may be calculated.

The partial differential matrix (Jacobian) Hₖ at the measurement update (2) in the general expression of the Extended Kalman Filter may be calculated by partially differentiating the observation values h expressed by the equation (1)-3 shown in FIG. 27.

The residual covariance Sₖ (3) in the general expression of the Extended Kalman Filter (See FIG. 28) may be calculated by using the following observation noise (matrix) Rₖ, which is the error data output from the first position acquisition unit 401, the partial differential matrix at measure update Hₖ, the transposed matrix Hₖ^{T}, and the residual covariance matrix at present P_{k|k-1}.

$${R}_{k} = {σ}_{1} = [ \begin{matrix}{r}_{1} & 0 & 0 \\ 0 & {r}_{2} & 0 \\ 0 & 0 & {r}_{3}\end{matrix} ]$$

Here, r₁ indicates an x-axis component, r₂ indicates a y-axis component, and r3 indicates a z-axis component.

The Kalman gain Kₖ (4) in the general expression of the Extended Kalman Filter (See FIG. 28) may be calculated from the error covariance matrix at present P_{k|k-1}, the transposed matrix Hₖ^{T}, and the inverse matrix of the residual covariance Sₖ⁻¹.

The updated state estimate values (5) and the updated error covariance matrix P_{k|k} (6) in the general expression of the Extended Kalman Filter (See FIG. 28) may be calculated using the variables which have been calculated in the above-mentioned procedure.

The second measurement update calculation unit 503 may execute the measurement update procedure of the Extended Kalman Filter and calculate or update the current position and error data 505 of the inertial device 1 as well as the first measurement update calculation unit 502. The variables in the Extended Kalman Filter are similar to ones used by the first measurement update calculation unit 502 except that the observation values zₖ and the observation noise Rₖ are the absolute positional data and error data which have been output from the second absolute position acquisition unit 402.

The third measurement update calculation unit 504 may execute the measurement update procedure of the Extended Kalman Filter and calculate or update the current position and error data 505 of the inertial device 1 as well as the first measurement update calculation unit 502. The variables in the Extended Kalman Filter are similar to ones used by the first measurement update calculation unit 502 except that the observation values zₖ and the observation noise Rₖ are the absolute positional data and error data which have been output from the map-matching unit 600 which is discussed later.

The absolute position estimate unit 500 may update the current position and error data 505 in the framework of the Extended Kalman Filter thereby estimating the current position with great accuracy. An application installed on the inertial device 1 may refer to the current position and error data 505 and acquire a direction of the inertial device (heading information and estimated yaw angle information) in addition to the estimated current position.

### 4.4 Map-Matching

The map-matching unit 600 has a map-matching calculation unit 601. The map-matching unit 600 may acquire the latest current position and error data 505 and the velocity estimate vector 316 and execute a map-matching procedure.

The map-matching calculation unit 601 may acquire the latest current position and error data 505 and the velocity estimate vector 316; refer to a map database (DB) 602 which is prepared in advance; and acquire area data representing an area in which the target may walk or travel. Next, the map-matching calculation unit 601 may execute the map-matching procedure by using a known particle filter algorithm (See Non-patent document 6). When the current position is on an area in which the target may not walk or travel, the map-matching calculation unit 601 may correct the current position to be the area, in which the target may walk or travel. In addition, the map-matching calculation unit 601 may calculate an error covariance matrix σₘ representing an amount of error at each component of the positional vector for the corrected position. The map-matching calculation unit 601 may transmit the positional vector (Xₘ, Yₘ, Zₘ) representing the corrected position and the error covariance matrix σₘ to the third measurement update calculation unit 504.

As discussed above, the inertial device 1 according to this embodiment combines a plurality of the velocity waveforms generated from the parameters 307-311 representing motion characteristics of the target and calculates the velocity based on the combined waveform. The parameters are stored in the database after having been associated with the characteristics of the target. One of the velocity waveforms is generated so as to match the target and its motion. In addition, the equations representing the velocity waveform are represented by a plurality of members (models). Each of the members includes a weight indicating the degree of reliability for the member. Therefore, the velocity may be estimated with high resolution performance and a high degree of reliability.

In addition, the inertial device 1 according to this embodiment may calculate the current position with a high degree of accuracy by using the velocity and its error data, which are relative data, as well as the absolute positional data and its error data. Furthermore, the inertial device 1 may improve the accuracy of the calculation for the current position by correcting the current position using the map-matching procedure with the map database 602.

### 5. Estimate Result of Velocity and Current Position

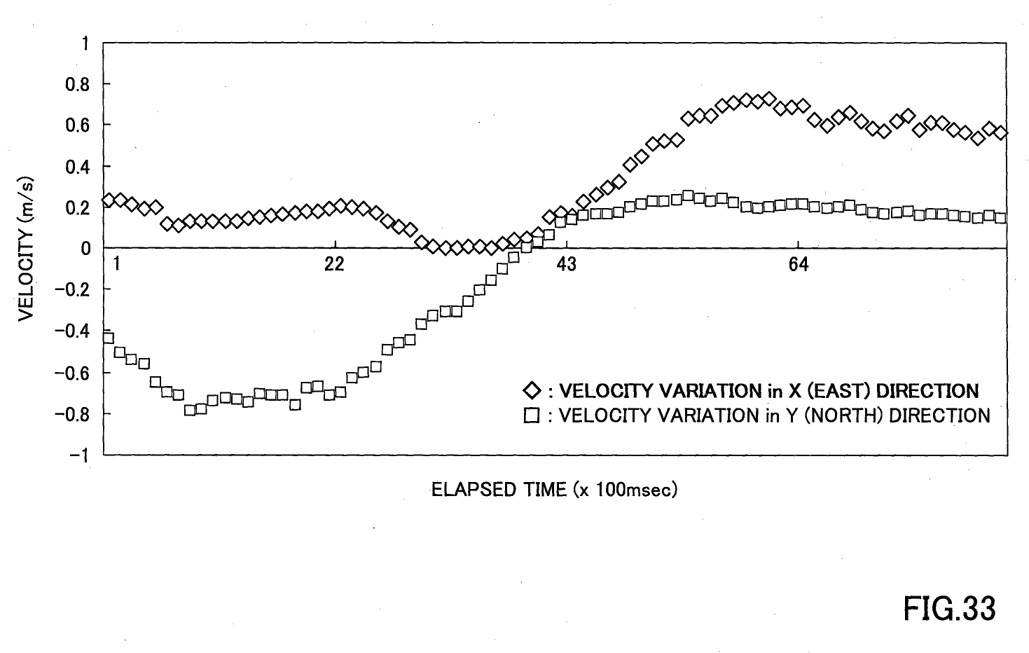

With reference to FIGS. 33-37, results of the estimation for the velocity and the current position using the inertial device 1 according to an embodiment of the present invention are explained.

The inertial device 1 according to this embodiment has an acceleration sensor, a gyro censor, and a magnetic field sensor. In addition, the inertial device 1 has a GPS/IMES module and a Bluetooth™ module for obtaining absolute positional data as a positioning unit. The inertial device 1 is a mobile terminal in the form of a smartphone having the above-mentioned devices.

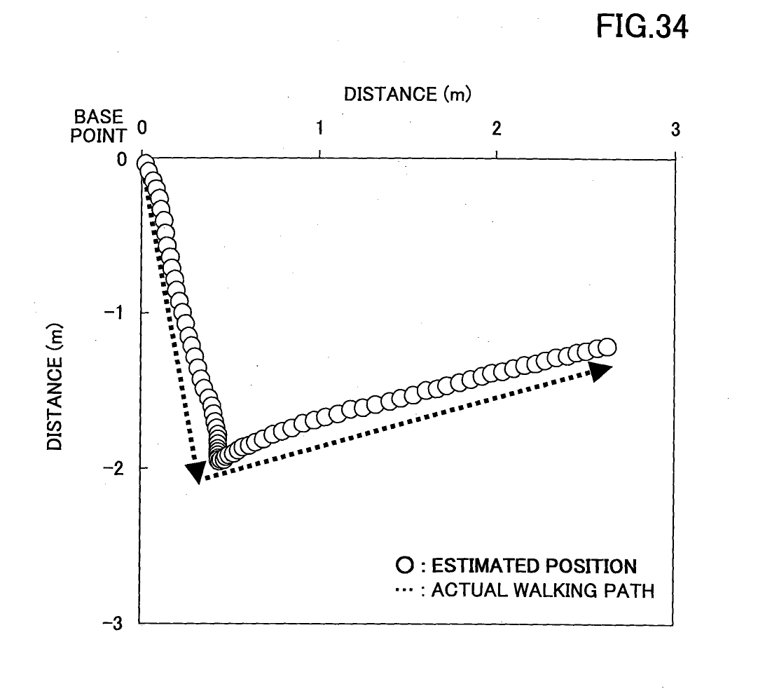

FIG. 33 shows a result of the estimated velocity when the inertial device 1 is mounted on the waist part of a walking user. As shown in FIG. 34, the user goes straight about 2 meters at first, and then turns 90 degrees to the left, and again goes straight. The horizontal axis in FIG. 33 represents elapsed time (100 milliseconds) and the vertical axis represents the velocity (meter per second). FIG. 33 shows a time window about 8 seconds while the user walks. Within the time window, the user holding the inertial device 1 walks 7 steps.

FIG. 33 shows waveforms in the horizontal direction (i.e. x and y directions) combined by the velocity waveform combination unit 314. The waveform is combined from waveforms generated by the velocity waveform generation unit 312 using parameters such as the direction obtained by the direction estimate unit 200, the cycle, the amplitude, etc. As shown in FIG. 33, the inertial device 1 may output the velocity for walking motion with high resolution performance (i.e. 100 ms).

FIG. 34 shows a result of the estimated current position when the inertial device 1 is mounted on the waist part of a walking user. As illustrated by arrows with dotted lines in FIG. 34, the user goes straight about 2 meters at first, and then turns 90 degrees to the left, and again goes straight. Circles shown in FIG. 34 indicate a history of the current positions which are estimated by the absolute position estimate unit 500 based on the current velocities obtained from the velocity waveform shown in FIG. 33. As shown in FIG. 34, the history of the current positions estimated by the inertial device 1 mostly correspond with the actual walking path.

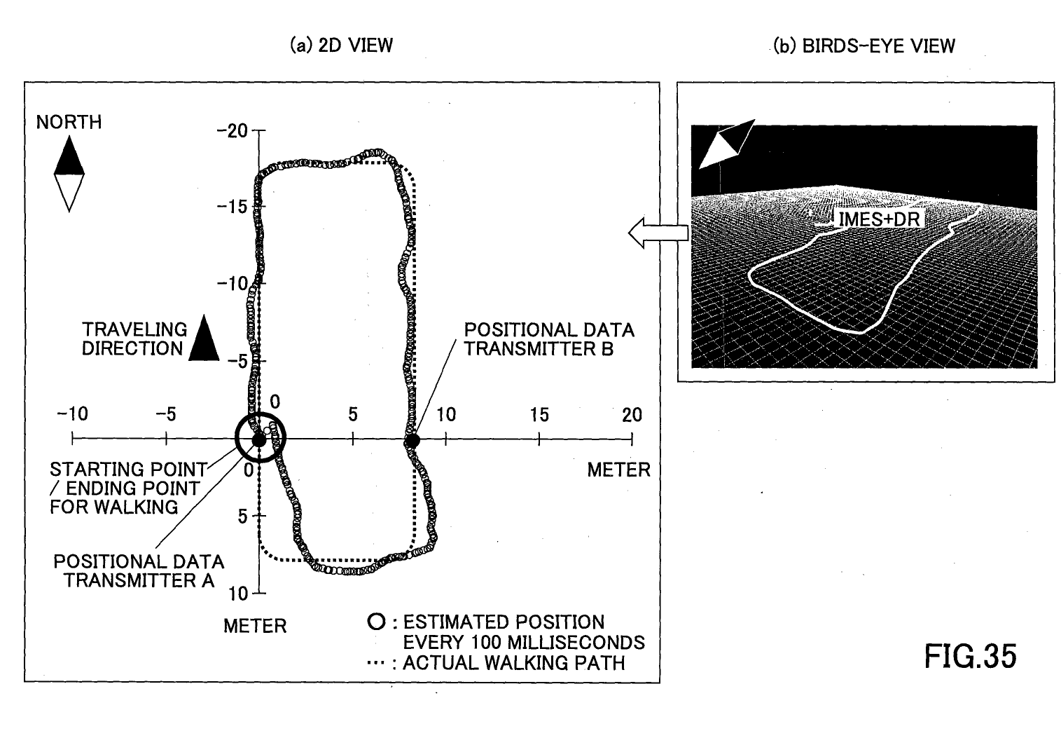

FIG. 35 shows a result of the estimated current position when a user holds the inertial device 1 in his hand. In this case, the user goes around about 75 meters in a clockwise fashion (92 steps total). On the walking path, two positional data transmitters A and B, which transmit the absolute positional data (latitude and longitude) and its error data via the IMES, are installed. Thus, the inertial device 1 may estimate the current position based on both the sensor data and the positional data transmitted from the positional data transmitter.

In the FIG. 35, a dotted line indicates the actual walking path of the user, and circles indicate a history of the current positions obtained by the inertial device 1. As shown in FIG. 35, the inertial device 1 may estimate the current position with high time resolution performance (i.e. 100 ms) and achieve high accuracy estimation for actual walking. In addition, the time resolution performance is configurable by changing the parameters.

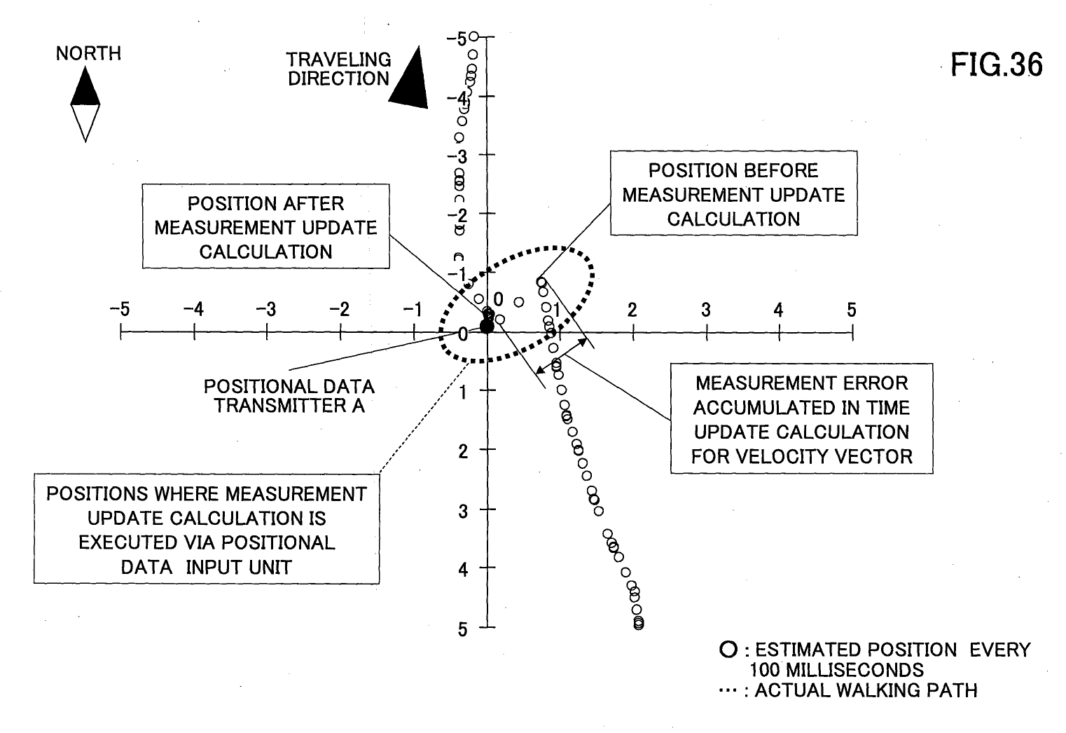

FIG. 36 is an enlarged view of the result shown in FIG. 35 around the starting (or ending) point for the walking. As shown in FIG. 36, a measurement error about 1 m is observed just before the ending point (i.e. a position before the inertial device 1 executes the measurement update procedure using the positional data from the positional data transmitter A). This occurs for the following reason.
(1) The estimated velocity at present obtained by the velocity waveform combination unit 314 includes an error.
(2) Such an error is accumulated in the time update procedure for the estimated velocity.
   The result shows that the error of the estimation falls within an admissible range.

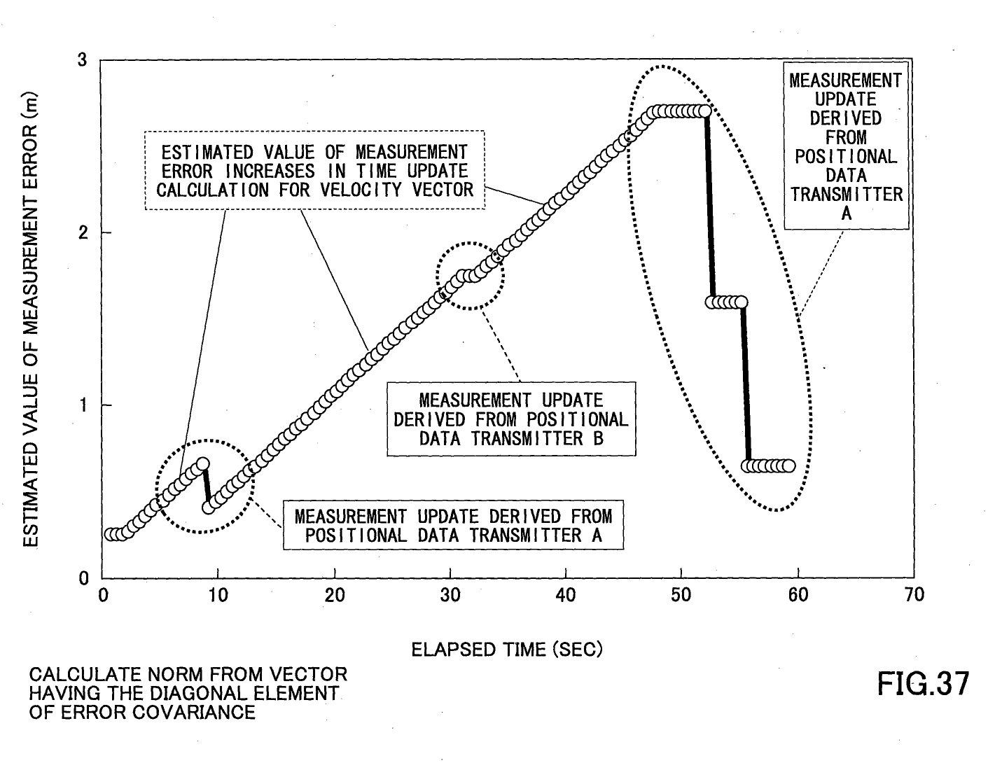

FIG. 37 shows variation of measurement errors estimated by the Kalman Filter in the walking motion as shown in FIG. 35. The inertial device 1 may estimate the error included in the velocity from the velocity waveform combination unit 314 and the error of the current position as the error covariance matrix in the framework of the Kalman Filter. As shown in FIG. 37, the estimated values of the measurement errors (square-root of sum of squares for a diagonal component of the error variance matrix) estimated by the Kalman Filter increase as the user walks.

On the other hand, when the inertial device 1 may receive the absolute positional data and the error data from the positional data transmitter, the inertial device 1 compares the measurement error about the positioning means of the positional data transmitter with the estimated value of the measurement error estimated by the Kalman Filter for the current position. Next, the inertial device 1 corrects the estimated value of the present position so that the covariance values in the error covariance matrix become smaller. As shown in FIG. 37, the estimated value of the measurement error estimated by the Kalman Filter decreases when the inertial device 1 executes the measurement update procedures using data from the positional data transmitters A and B. As a result, the inertial device 1 may correct the estimated current position and improve accuracy to estimate the position using the absolute positional data and the error data obtained from the external device.

Again with reference to FIG. 36, it is observed that the accumulated measurement errors are corrected and the current position is fixed to the correct position (the ending point of walking) by executing the measurement update procedure based in the absolute positional data input just before the user finishes walking.

As discussed above, the inertial device 1 according to the embodiment improves the resolution performance and the degree of accuracy for estimation of user's current position. As a result, a convenient inertial device and inertial navigation technique are achieved which enable a user to hold the device in any form.

In the above-mentioned embodiment, the programs executed in each device explained in the embodiment may be in an installable format or in an executable format on a computer-readable recording medium such as a CD-ROM, a flexible disk (FD), a CD-R, or a digital versatile disk (DVD).

The programs executed on each device according to the embodiment may be stored on a computer connected to a network such as the Internet and may be provided by downloading via the network. The programs executed on each device according to the embodiment may be provided or distributed with the network such as the Internet.

Alternatively, the programs executed on each device according to the embodiment may be stored in the ROM in advance and provided.

The above-mentioned inertial device, method, and program are not limited to the above embodiments and various variations and modifications may be made without departing from the scope of the present invention. In addition, it is possible to form various inventions by combining any elements which are mentioned above.

The present application is based upon and claims the benefit of priority of Japanese Patent Application No. 2013-019210 filed on Feb. 4, 2013, and Japanese Patent Application No. 2013-230548 filed on Nov. 6, 2013, the entire contents of which are incorporated herein by reference.

### CITATION LIST

### Patent Literature

[Patent Document 1] Japanese Laid-open Patent Publication No. 2012-088253
[Patent Document 2] Japanese Patent No. 4714853
[Patent Document 3] Japanese Laid-open Patent Publication No. 2003-302419
[Patent Document 4] Japanese Laid-open Patent Publication No. 2011-237452
[Patent Document 5] Japanese Laid-open Patent Publication No. 2000-97722
[Patent Document 6] Japanese Laid-open Patent Publication No. 2002-139340

### Non Patent Literature

[Non-Patent Document 1] Greg Welch and Gary Bishop, “An Introduction to the Kalman Filter”, Department of Computer Science, University of North Carolina at Chapel Hill, Jul. 24, 2006
[Non-Patent Document 2] Tohru Katayama, “Applied Kalman Filtering, New Edition”, Asakura Bookshop, Jan. 20, 2000
[Non-Patent Document 3] Wei Tech Ang et al., “Kalman filtering for real-time orientation tracking of handheld microsurgical instrument”, Intelligent Robots and Systems, 2004 (IROS 2004). Proceedings. 2004 IEEE/RSJ International Conference, Sep. 28, 2004, Volume 3, p.2574-2580 vol.3
[Non-Patent Document 4] Malcolm D. Shuster, “Deterministic Three-Axis Attitude Determination”, The Journal of the Astronautical Sciences, July 2004, Volume 52, No. 3, p.405-419
[Non-Patent Document 5] “TRIAD Algorithm”, [online] May 25, 2011, Wikipedia, Internet, <URL:http://en.wikipedia.org/wiki/User:Snietfeld/TRIAD_Algorithm>
[Non-Patent Document 6] I. M. Rekleitis, “A particle filter tutorial for mobile robot localization”, Technical Report TR-CIM-04-02, Centre for Intelligent Machines, McGill University, 2004

1. An inertial device comprising:
an inertial sensor unit configured to generate an output representing motion of a target holding the inertial device;
a storage unit configured to store factors which are associated with different outputs to be generated by the inertial sensor unit, respectively;
a generation unit configured to generate a waveform which represents variation of velocity of the inertial device in a predetermined period by using one of the factors corresponding to the output generated by the inertial sensor unit;
a combination unit configured to combine the waveform with one or more previous waveforms which have been generated by the generation unit; and
an estimation unit configured to estimate a position where the inertial device is currently located using a velocity obtained from the combined waveform.

2. The inertial device as claimed in claim 1,
wherein the factors are also associated with attributes of the target holding the inertial device, and the generation unit generates the waveform using the one of the factors corresponding to both the output generated by the inertial sensor unit and one of the attributes of the target holding the inertial device.

3. The inertial device as claimed in claim 1,
wherein the output includes at least one of a velocity in a horizontal direction; an acceleration in a vertical direction; a cycle of the traveling motion; a traveling direction of the inertial device; and an amplitude of the traveling motion from side to side to the traveling direction.

4. The inertial device as claimed in claim 1,
wherein the estimation unit estimates the position where the inertial device is currently located using both the velocity and given error data representing a degree of error in calculating the velocity.

5. The inertial device as claimed in claim 4, further comprising:
an input unit configured to input absolute positional data, which is received from a positional data transmitter, and error data of the absolute positional data into the estimation unit; wherein the estimation unit updates the estimated position using the absolute positional data and the error data of the absolute positional data.

6. The inertial device as claimed in claim 5, further comprising:
a measurement unit configured to measure an interval to receive the absolute positional data; and
a correction unit configured to correct the error data of the absolute positional data according to the measured interval.

7. The inertial device as claimed in claim 5, wherein the input unit inputs other absolute positional data, which is received from other positional data transmitters employing communication methods different from each other, and error data of the other absolute positional data into the estimation unit.

8. The inertial device as claimed in claim 7,
wherein the input unit inputs the other absolute positional data received from one of the other positional data transmitters via communications conforming to the Indoor Messaging System (IMES) standard.

9. The inertial device as claimed in claim 1, further comprising:
a map matching unit configured to match the estimated position to a map defining permitted areas in which the target is permitted to enter and forbidden areas in which the target is not permitted to enter and to correct the position when the estimated position is in the forbidden areas, wherein the estimation unit updates the estimated position according to the corrected position.

10. A method comprising:
generating an output representing motion of a target holding an inertial device using an inertial sensor;
generating a waveform which represents variation of velocity of the inertial device in a predetermined period by using one of factors corresponding to the output, the factors being associated with different outputs to be generated by the inertial sensor;
combining the waveform with one or more previous waveforms which have been generated in the generating step of the waveform; and
estimating a position where the inertial device is currently located using a velocity obtained from the combined waveform.

11. A program for causing an inertial device to perform a method comprising:
generating an output representing motion of a target holding the inertial device using an inertial sensor;
generating a waveform which represents variation of velocity of the inertial device in a predetermined period by using one of factors corresponding to the output, the factors being associated with different outputs to be generated by the inertial sensor;
combining the waveform with one or more previous waveforms which have been generated in the generating step of the waveform; and
estimating a position where the inertial device is currently located using a velocity obtained from the combined waveform.
